(19) United States
(12) Patent Application Publication
(10) Pub. No.: US 2026/0023569 A1
(43) Pub. Date: Jan. 22, 2026

(54) SPECULATIVE INVOCATION OF ACCELERATORS IN OUT-OF-ORDER PIPELINES

(71) Applicant: Intel Corporation, Santa Clara, CA (US)

(72) Inventors: Gerasimos Gerogiannis, Champaign, IL (US); Stijn Eyerman, Evergem (BE); Wim Heirman, Aalter (BE)

(21) Appl. No.: 19/342,390

(22) Filed: Sep. 26, 2025

(51) Int. Cl. G06F 9/38; G06F 9/30

(52) U.S. Cl. CPC G06F 9/3842; G06F 9/3013; G06F 9/3856

(57) ABSTRACT

Techniques for speculative invocation of accelerators in out-of-order pipelines are described. In some examples, a processor core at least comprising: decoder circuitry to at least decode an accelerator task instruction, scheduling circuitry to at least schedule the decoded accelerator task instruction to execute on an accelerator, a port coupled to the accelerator, and at least one register to store a result of the decoded accelerator task instruction; is coupled to the accelerator to execute the decoded accelerator task instruction and provide the result to the processor core through the port coupled to the accelerator.

### BACKGROUND

Central processing units (CPUs) have been challenged by more efficient and/or better performing architectures such as graphics processing units (GPUs) and application specific integrated circuit (ASIC) accelerators. These architectures use specialized hardware designed for certain computational tasks to deliver substantial improvements in domains such as machine learning and/or scientific computing. However, to this day, CPUs remain the only architecture that is sufficiently programmable to execute any application.

Often, as applications evolve, these applications exceed what is computationally possible by specialized hardware and/or demand more memory than what is available in specialized architectures. When this happens, accelerators fallback to their CPU hosts for assistance. Unfortunately, interleaving CPU and accelerator phases often includes substantial overhead (e.g., due to data movement) which decreases the end-to-end efficiency.

### BRIEF DESCRIPTION OF DRAWINGS

Various examples in accordance with the present disclosure will be described with reference to the drawings, in which:

FIG. 1 illustrates examples of a system using an accelerator.

FIG. 2 illustrates examples of accelerator task instruction formats.

FIG. 3 illustrates examples of a core that supports accelerator usage wherein one or more results produced by the accelerator are returned as register data to the core.

FIG. 4 illustrates examples of a reorder buffer.

FIGS. 5(A)-(D) illustrate examples of loads and memory consistency.

FIG. 6 illustrates an example method performed by a processor core to process an instruction using an accelerator.

FIG. 7 illustrates an example method performed by an accelerator to process an instruction from a processor core.

FIG. 8 illustrates an example computing system.

FIG. 9 illustrates a block diagram of an example processor and/or System on a Chip (SoC) that may have one or more cores and an integrated memory controller.

FIG. 10 is a block diagram illustrating a computing system 1000 configured to implement one or more aspects of the examples described herein.

FIGS. 11A-11B illustrate a hybrid logical/physical view of a disaggregated parallel processor, according to examples described herein.

FIG. 12(A) is a block diagram illustrating both an example in-order pipeline and an example register renaming, out-of-order issue/execution pipeline according to examples.

FIG. 12(B) is a block diagram illustrating both an example in-order architecture core and an example register renaming, out-of-order issue/execution architecture core to be included in a processor according to examples.

FIG. 13 illustrates examples of execution unit(s) circuitry, such as execution unit(s) circuitry.

FIG. 14 is a block diagram of a register architecture according to some examples.

FIG. 15 illustrates examples of an instruction format.

FIG. 16 illustrates examples of an addressing information field.

FIGS. 17(A)-(B) illustrate examples of a first prefix.

FIGS. 18(A)-(D) illustrate examples of how the R, X, and B fields of the first prefix are used.

FIGS. 19(A)-(B) illustrate examples of a second prefix.

FIGS. 20(A)-(E) illustrate examples of a third prefix.

FIG. 21 is a block diagram illustrating the use of a software instruction converter to convert binary instructions in a source ISA to binary instructions in a target ISA according to examples.

FIG. 22 is a block diagram illustrating an IP core development system that may be used to manufacture an integrated circuit to perform operations according to some examples.

### DETAILED DESCRIPTION

The present disclosure relates to methods, apparatus, systems, and non-transitory computer-readable storage media for accelerator usage.

The flexibility of a CPU can lead to inefficiencies. For example, the sequential programming model used by CPUs limits the achievable parallelism and its fine-grained compute, memory, and control instruction set architecture may cause a high control overhead which requires many instructions to implement an algorithm. Due to this overhead, increasing the compute and memory throughput of a CPU core is challenging. Out-of-order execution, multiple cache levels, branch prediction, speculation, and vector and matrix functional units are examples of ways to increase a CPU core's throughput. However, the complexity needed to extract this parallelism increases super linearly with the required parallelism. This decreases its efficiency up to a point where it is no longer efficient to further scale to reach higher parallelism.

One existing “solution” to address CPU inefficiencies is to add more cores and increasing throughput linearly in the number of cores. However, adding cores requires writing parallel applications that can make use of these cores (this is a historically challenging task for compilers and/or operating systems to perform). Adding cores also complicates CPU design, as these cores occupy chip area and they all need to access memory (either directly or indirectly). Thua adds complexity to intra-chip networking and cache coherence and synchronization, etc.

Another “solution” is to include system-on-a-chip (SoC)-level accelerators that can perform specific operations and autonomously access memory to fetch the data they need. For example, neural processing units (NPUs) are accelerators that are used for dense linear algebra (e.g., for inference using a machine learning model), compression, and/or cryptography. A core can initiate an operation on these accelerators, but it has no control over the instructions or algorithms of these accelerators.

In a conventional communication scheme between a core and an accelerator, the accelerator is treated as a memory-mapped input/output (MMIO) device. Communication between the core and accelerator includes the core initializing a task and invoking the accelerator by writing to memory-mapped (e.g., non-core) registers. The accelerator independently starts and executes the task. When the task is finished, another memory-mapped register or memory location is set by the accelerator to indicate its finalization. The core polls on that memory location (e.g., through regular loads) to find out when the task is done and when the output data can be read from memory and processed further. All data communication between the devices goes through memory. For correctness, fences are required between accelerator invocations (memory stores) and accelerator polling (memory loads) to prevent load to store bypassing. Pipelined accelerator execution and parallelism are supported by providing multiple task start and finish slots, e.g., in a work queue.

This type of communication does not work well for fine-grained tasks and close interaction with the core. Because the task writes directly to memory, the task cannot be issued speculatively, meaning that the task initialization instruction has to wait until it is at the head of a reorder buffer (ROB) of a core and all instructions that are dependent on the task have to wait. The core has no control over offloaded tasks in this configuration—it cannot stop a task or partially re-execute the task after an interrupt (the entire task has to be redone). Further, the core cannot issue these tasks out-of-order with older instructions or execute these tasks speculatively thereby limiting the execution overlap between the accelerator tasks and core instructions, and between the accelerator tasks themselves.

In conventional configurations, an accelerator cannot be invoked out-of-order. As the accelerator invocation is a store the invocation will only be issued when it reaches the head of the ROB. Further, accelerator invocations are serialized which means there are the latencies of different accelerator stores that cannot overlap. Note that this does not mean that accelerator tasks cannot overlap, but that the latencies for starting the tasks cannot overlap. Additionally, as noted above, fences are needed between accelerator stores and accelerator loads for correctness. This prevents normal (non-accelerator) loads from bypassing stores which effectively serializes all of the memory operations.

Examples detailed herein describe the uses of one or more near-core accelerators (NCAs) that perform some tasks more efficiently than the CPU core would do with conventional instructions. These NCAs are controlled directly by the core. An example of a task could be to multiply two (sparse) vectors or a few rows of a (sparse) matrix, dequantize and de-sparsify compressed data, etc. A NCA communicates with a core through instructions, buffers, and/or registers. For example, an NCA's output is written to one or more CPU registers and not to memory. While this may limit the size of a task (e.g., a result cannot exceed what can be stored in registers of the CPU) it enables tighter control by the core to change the control flow depending on the output of the NCA's calculations.

Examples detailed herein describe a class of instructions (which may be called accelerator task instructions which may be a part of an Accelerator Task eXtension (ATX) instruction set architecture (ISA)) that operates as regular instructions in the CPU core but start a task on an accelerator. To support speculative and out-of-order execution, and thus high performance, results of accelerator task instructions do not write to memory, only to core registers. For example, an accelerator performs the tasks and provides the results to one or more registers of the core. Accelerator tasks initiated by accelerator task instructions may execute as micro-threads that are independent from a main thread.

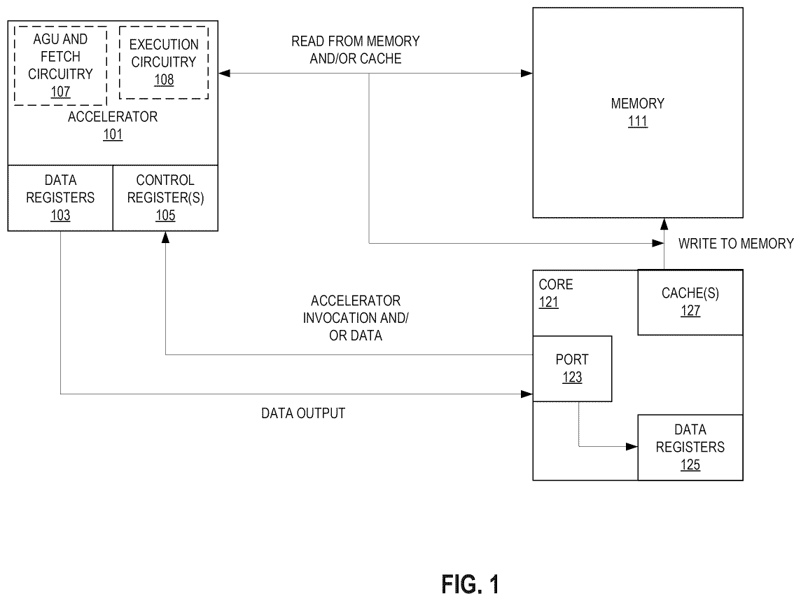

FIG. 1 illustrates examples of a system using an accelerator. As shown, a core 121 (e.g., a CPU processor core, etc.) is coupled to an accelerator 101. The accelerator 101 is to be invoked by the core 121 using an instruction. Non-limiting examples of accelerators that may be invoked may include one or more a data streaming accelerator, an in-memory analytics accelerator, a dynamic load balancer, matrix accelerator, a tensor core, a vision processing unit, a quantum computing accelerator, an encryption/decryption accelerator, a pointwise arithmetic accelerator, a polynomial operation accelerator, etc.

In some examples, the accelerator 101 is integrated into the core 121. In some examples, the accelerator 101 is tightly coupled to the core 121. In some examples, the accelerator 101 attached to a level of cache 127 of the core (e.g., L2 or LLC). An accelerator coupled to cache enables fast CPU-accelerator message exchange.

The core 121 sends the invocation of the accelerator 101 using a port 123. In some examples, there is a port per accelerator. In some examples, there is a port per accelerator operation. In some examples, a port is multiplexed between accelerators.

In some examples, the invocation is one or more accelerator instruction(s) or command(s) that the accelerator 101 understands. In some examples, the one or more instruction(s) or command(s) are generated by converting from an instruction understood by the core 121. For example, the core 121 may have a binary translator, etc. to convert an instruction from one format to a different format instruction or command. In some examples, the accelerator 101 performs a translation to accelerator specific instruction(s) and/or command(s).

In some examples, the accelerator 101 utilizes one or more control registers 105 to configure execution, by execution circuitry 108, of the accelerator instruction and/or command.

For example, one or more control registers 105 may be used to indicate which operation to perform, where to get source data, data element sizes, etc. The execution circuitry 108 may support one or more of data streaming, in-memory analytics, a dynamic load balancing, matrix operations, tensor operations, quantum operations, encryption/decryption operations, pointwise arithmetic, polynomial operations, etc.

Data registers 103 of the accelerator 101 (or buffers of the accelerator 101) are used to send data output to the data registers 125 of the core. If data needs to be written to memory, the core 121 performs this writing using core store infrastructure which ensures non-speculative stores and memory consistency. Accelerator task instructions can cause the accelerator 101 to read from memory 111 to fetch the inputs for their operations. Furthermore, the accelerator 101 does not keep state across instructions as each instruction only uses the data it gets and the data it loads from memory. In some examples, the accelerator includes an address generation unit to generate a physical address and fetch circuitry to load data from memory or cache.

In the core 121, accelerator task instructions behave like load instructions that load data from memory and write to a register. Intermediate computations on the loaded data are not visible/important for the core 121. As such, the core 121 treats these instructions as a normal load which can be issued speculatively and/or out-of-order (as soon as the instructions that produce its register inputs have finished). If an accelerator task instruction is squashed because of wrong speculation, the instruction can be interrupted in the accelerator 101 without saving any state. If the accelerator task instruction is re-executed, the data is loaded again and the accelerator 101 performs the calculations using execution circuitry 108.

The output register(s) 103 and/or data registers 125 may come in different sizes and/or support different data elements sizes. For example, registers may be scalar and support 1-bit, 2-bit, 4-bit, 16-bit, 32-bit, 64-bit, etc. data elements (integer and/or floating point including 8-bit floating point (e.g., FP8 (e.g., using a 1-4-3 format), INT8, BF8 (e.g., using a 1-5-2 format), etc.), Bfloat16, half-precision, full-precision, double-precision, quad-precision, etc.) and may be 1-bit, 2-bit, 4-bit, 16-bit, 32-bit, 64-bit, 128-bit, 256-bit, 512-bit, 1024-bit, 2048-bit, etc. in size; single input, multiple data (SIMD)/vector registers that support multiple 1-bit, 2-bit, 4-bit, 16-bit, 32-bit, 64-bit, etc. data elements (integer and/or floating point including 8-bit floating point (e.g., FP8 (e.g., using a 1-4-3 format), INT8, BF8 (e.g., using a 1-5-2 format), etc.) and may be 1-bit, 2-bit, 4-bit, 16-bit, 32-bit, 64-bit, 128-bit, 256-bit, 512-bit, 1024-bit, 2048-bit, etc. in size; matrix registers (which may be called tile registers) that support 1-bit, 2-bit, 4-bit, 16-bit, 32-bit, 64-bit, etc. data elements (integer and/or floating point including 8-bit floating point (e.g., FP8 (e.g., using a 1-4-3 format), INT8, BF8 (e.g., using a 1-5-2 format), etc.), Bfloat16, half-precision, full-precision, double-precision, quad-precision, etc.), etc.

The data loaded from memory by a task can be much larger than the size of a register if the operation contains a reduction (e.g., a vector dot product). Tasks are also limited by the data that can be stored internally in the NCA (after loading it from memory). Depending on the functionality of the accelerator, this internal buffer should be sized according to the output register size (and the degree of data reduction).

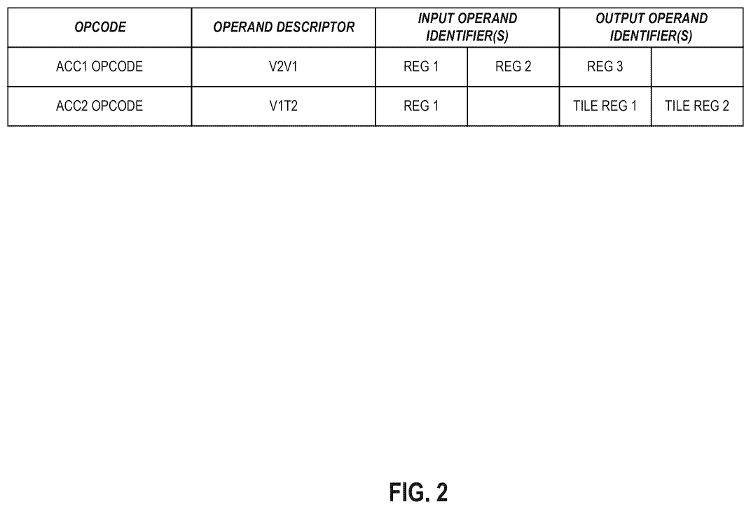

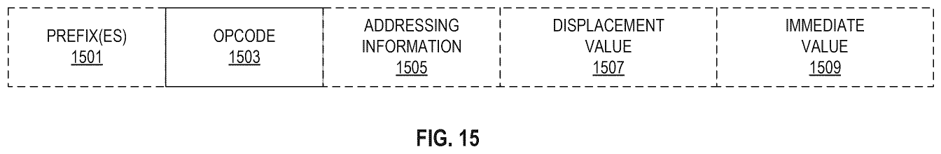

FIG. 2 illustrates examples of accelerator task instruction formats. An accelerator task instruction includes one or more fields for an opcode (e.g., opcode field 1503 of FIG. 15) that defines the accelerator and function to be executed. Accelerator task instructions can target different accelerators and/or each accelerator can implement different (variants of) functions.

In some examples, an operand descriptor field is provided (e.g., using a prefix 1501 of FIG. 15). In this illustration, V1T2 means that the instruction has one input vector register operand and two output tile/matrix register operands. In some examples, varying numbers of input and output register operands are allowed as accelerators may require a varying number of input arguments or may produce output varying in size.

One or more fields for identifying input source(s) and/or output register(s) are provided (e.g., from addressing information 1505, prefix information 1501, and/or a displacement value 1507). In some examples, an input register may contain a (base) addresses of the data that needs to be fetched, data to provide (if not provided by memory through cache or from the cache), the number of elements to fetch, etc. Input registers may also contain other configuration parameters, such as the size of an element (e.g., byte, word, double, quad, vector, etc.). One or more output register(s) are identified for the result of the accelerator's invocation. In some examples, an output size can be extended by supplying more than one output register.

A prefix, opcode, and/or immediate may be used to indicate data elements to retrieve, data element sizes, etc.

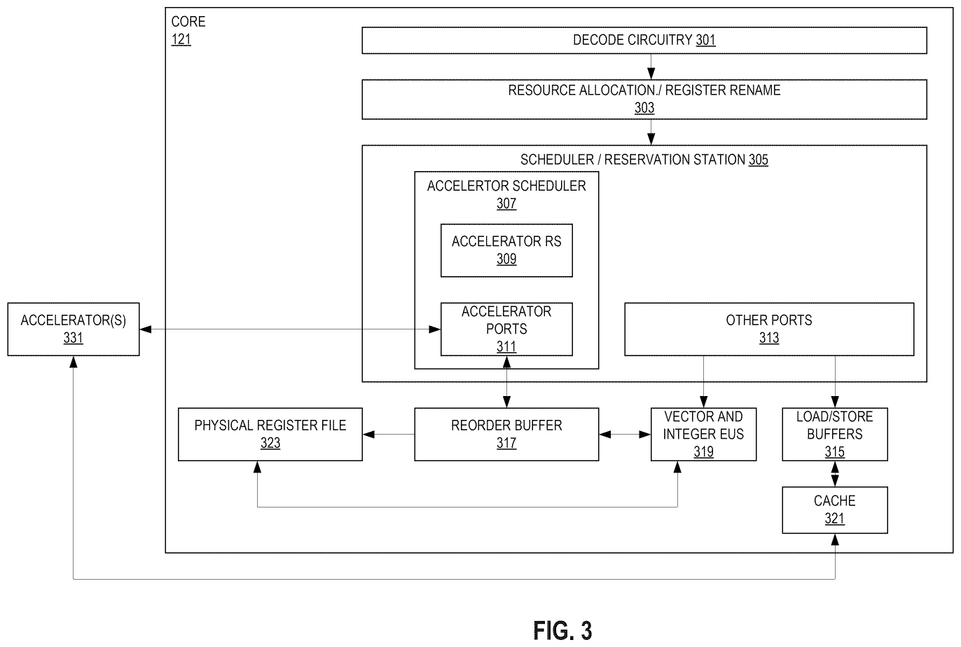

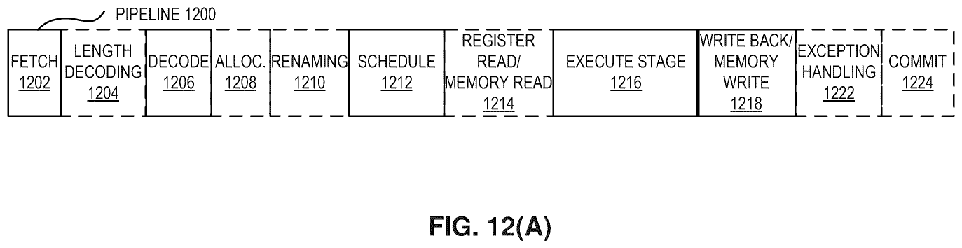

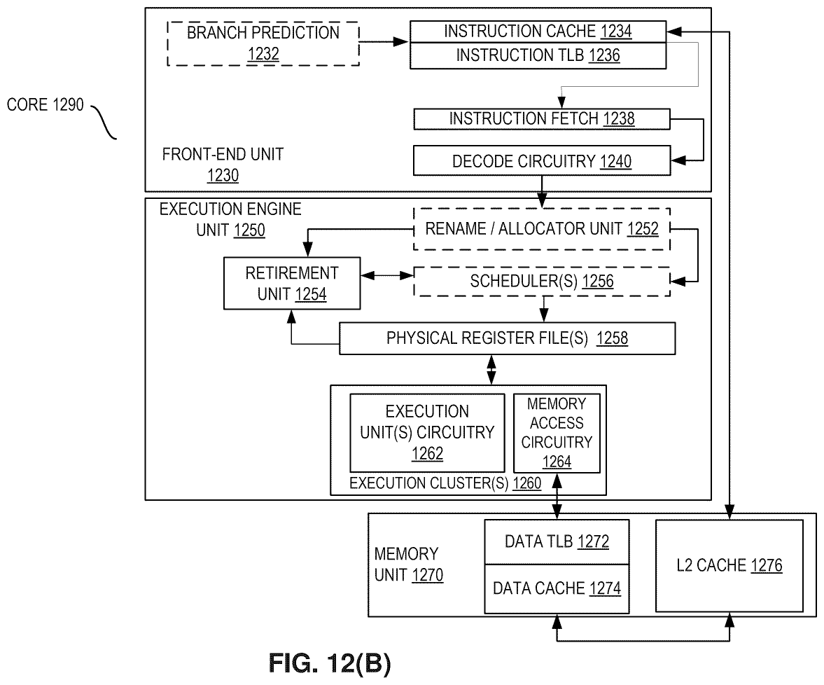

FIG. 3 illustrates examples of a core that supports accelerator usage wherein one or more results produced by the accelerator are returned as register data to the core. In some examples, the core is core 121 of FIG. 1. Note that this illustration does not show all combinatorial logic of a core such as a branch prediction unit (BPU), fetch circuitry, etc. that are shown with respect to other figures such as FIG. 12(B).

Decode circuitry 301 decodes instructions such as accelerator task instructions. Decoded instructions are passed to resource allocation/register rename circuitry 303 to allocate physical registers (e.g., of the physical register file 323) that have been renamed from logical registers for the instruction.

A scheduler 305 schedules execution of an instruction. In some examples, the scheduler 305 includes one or more reservation stations to allocate instructions to ports (e.g., ports 313 to vector and/or integer execution units 319 (that also perform Boolean operations and/or load/store buffers 315 and associated address generation units to load/store data from cache 321 (e.g., L1, L2, LLC, etc.) or memory. Reservation stations buffer instructions and their operands.

In some examples, an accelerator scheduler 307 schedules accelerator task instructions for one or more accelerators 331 through one or more accelerator ports 311. An accelerator reservation station (RS) 309 has a reservation station entry allocated when an instruction enters an execution engine (e.g., an accelerator).

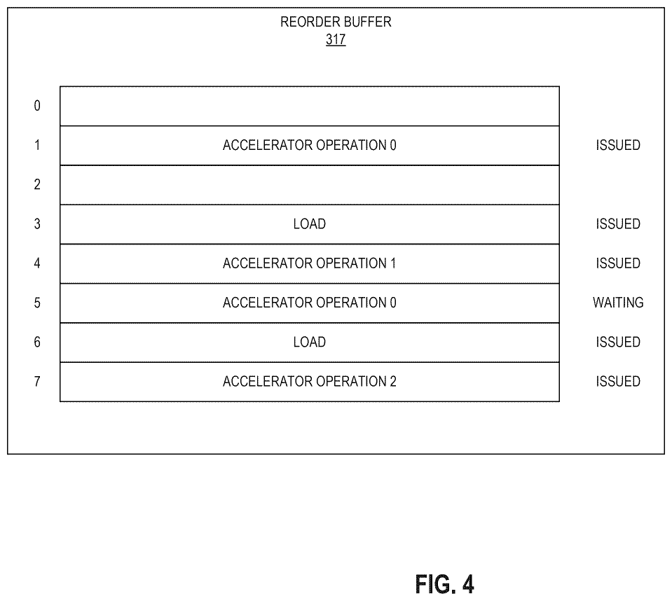

A ROB 317 records instructions, control information for those instructions, and the instruction order for the core. FIG. 4 illustrates examples of a ROB. In this example, there are four accelerator task instructions with three different opcodes. Accelerator operation 0 and accelerator operation 1 are accelerator task instructions handled by a first accelerator (accelerator 1), while accelerator operation 2 is an accelerator task instruction handled by a different accelerator (accelerator 2). The accelerator task instructions at ROB indices 1, 4, and 7 have already been issued to the accelerators. The one at index 5 is waiting since it has the same opcode as the one at index 1 which currently occupies a port slot. When an accelerator task instruction writes its output to a register in the physical register file 323 the instruction is considered done and the port can be freed before the instruction is committed or retired. When the port slot for a specific opcode is freed up, another accelerator task instruction with the same opcode can be issued to the accelerator. Some accelerators may support pipelining of specific functions. In this case, there are as many port slots as the pipeline parallel slots in the accelerator.

The accelerator ports 311 may contain a slot for each different accelerator task opcode supported by the architecture. New accelerator task instructions are dispatched from the frontend in the accelerator reservation station 309 and add to the ROB 317. When the (renamed) input registers are ready, the instruction is set to ready. If the port slot for a specific opcode is available, the first ready instruction with this opcode is sent to the appropriate accelerator. When an instruction is finished, the accelerator sets the instruction in the accelerator port to finished and the output registers to ready. Accelerator task instructions are committed in-order with the other instructions.

In some examples, accelerators have their own data fetch units to fetch data from a core local cache (e.g., L1 or L2). In some examples, an accelerator has its own memory management unit (MMU) with a translation lookaside buffer (TLB) and page walker to translate addresses. In some examples, an accelerator uses the core's MMU. In some examples, an accelerator uses a combination of its own resources and the core's resources to translate addresses (e.g., a private L1 TLB in the accelerator that is attached to the core's L2 TLB and page walker).

In some examples, accelerator task instructions load data from memory and may be executed speculatively which can create memory consistency issues. As noted above, accelerators executing an accelerator task instruction do not write to memory which ensures that no speculative state is written to memory. However, the load operations by the accelerators do not use the core's load queue, which means that these loads do not participate in the core's memory consistency checks.

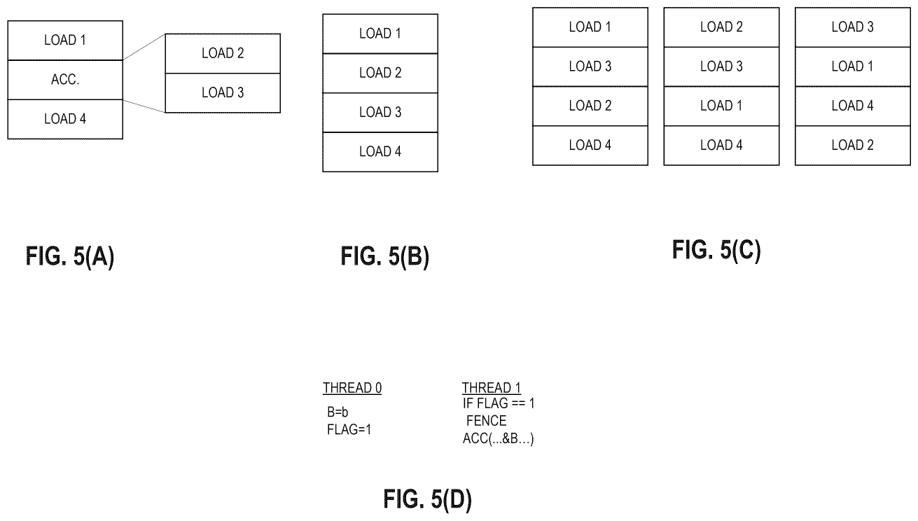

FIGS. 5(A)-(D) illustrate examples of loads and memory consistency. FIG. 5(A) illustrates a program order. In this illustration, there are two “normal” core loads (Load 1 and Load 4), and the accelerator task instruction causes two other loads (Load 2 and Load 3). The accelerator task instruction loads come after Load 1 in program order.

In some examples, the core uses total store ordering (TSO). One of the TSO guarantees is that loads appear as if they were executed in program order. For performance reasons, some cores still allow for loads to be speculatively executed out-of-order, assuming optimistically that this re-ordering will not have visible effects. In a single out-of-order core, this is ensured by the dependency checking through registers and memory addresses, but in a multi-core context, this might be violated if a younger load executes before an older load to the same address, and before that older load executes, the data is changed by another core. This ends up in the younger load reading the old value and the older one reading the new value, which cannot occur if the loads are executed in order. To detect cases where speculation may lead to visible ordering violations, the core keeps track of all the loads that have executed speculatively, and if a cache line is evicted or updated, all speculative loads are checked. If there was a speculative load to that address, there could be a violation, and the pipeline is flushed and re-executed starting from the violating load.

However, as noted above, in some examples an accelerator reads memory without relying on the core's general-purpose memory access infrastructure. Hence, loads done by the accelerator (e.g., Load 2 and Load 3) are not tracked by the core for potential memory ordering violations. As a result, there are more possible orderings between accelerator task loads and normal core loads than what would be allowed under TSO, leading to a more relaxed memory consistency model.

If an accelerator task instruction is executed as a micro-thread approach load ordering between the main thread and the load performed by the accelerator task instruction do not need to be enforced. If ordering between the loads in the main thread and an accelerator task instruction needs to be enforced, fences may be used. The order of the loads issued by the accelerator task itself depends on the accelerator implementation and cannot be enforced or checked by a memory consistency policy (as is the case for all accelerators) which resorts to weak ordering behavior within an accelerator task.

FIG. 5(B) illustrates an example of total store ordering for loads. In this illustration, the accelerator task loads are in order with the core loads.

FIG. 5(C) illustrates examples of relaxed ordering of loads. As shown, an accelerator task load can be in a different order with respect to other accelerator tasks loads. Further, an accelerator task load can appear reordered with a normal core load. An accelerator task load can also bypass core store. As such, accelerator task loads are weakly ordered with respect to core loads and accelerator task loads.

In some examples, programmers should account for the more relaxed memory consistency implications of accelerator task loads using one or more fences to enforce load order if the load order would impact correctness (e.g., a data dependence). FIG. 5(D) illustrates examples of using fences. Thread 0 writes to memory location B and sets a flag. Thread 1 reads the flag and then uses an accelerator task instruction which includes B among the addresses it will load. In Thread 1 the accelerator task load may executed before the load of the flag a fence is needed.

Another potential issue is store-to-load forwarding. An issue with store-to-load forwarding is that if the core writes to memory, it first writes the data to a local store queue, and only when the store is not speculative anymore (i.e., when it is at the head of the ROB) is the data is written to memory. If a load is executed speculatively, it first checks the store queue if an older store wrote to the location it wants to read from, and if that is the case, it fetches the data from the store queue instead of from memory.

The accelerator has no access to the core's store queue, so it cannot do these checks and loads data directly from memory (or cache). Using the micro-thread approach, the programmer/compiler should add a fence between a store and an accelerator task instruction if the latter can consume data produced by the former, such that the accelerator task instruction is only issued after the store is completed and written to the cache. Dynamic input data from the core to the accelerator should be communicated through input registers instead of through memory which is handled correctly through the existing dependency checking mechanism in the core without needing fences.

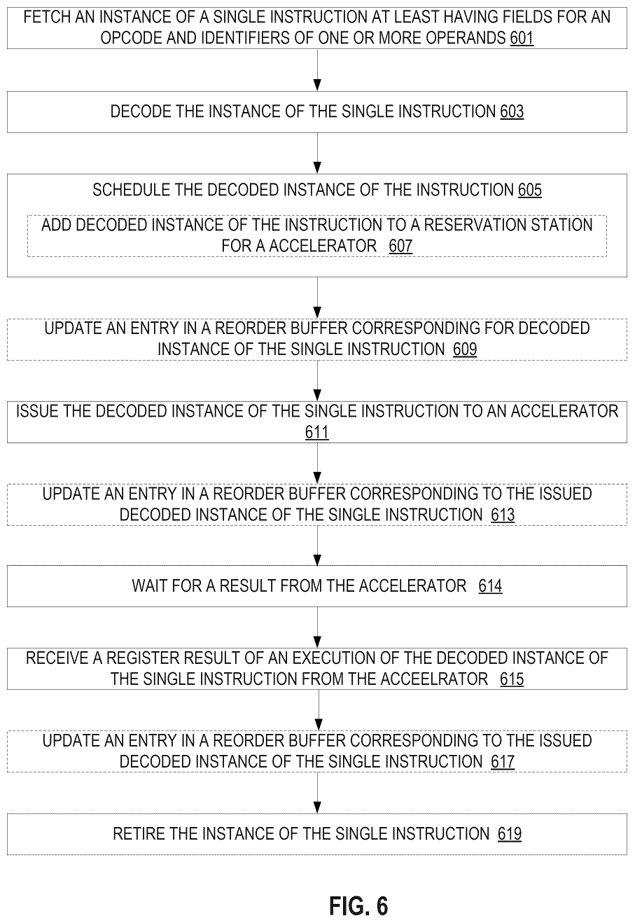

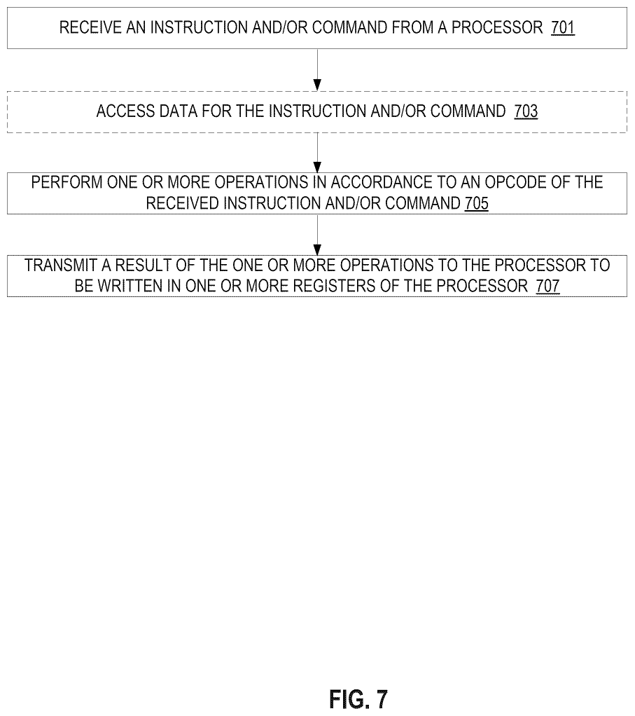

FIG. 6 illustrates an example method performed by a processor core to process an instruction using an accelerator. For example, a processor core as shown in FIGS. 12(B), 1, 3, a pipeline as detailed below, etc., performs this method. Note that this flow is from the processor's perspective only. Acts of the accelerator that is to execute an accelerator instruction and/or command in response to the instruction are not described. FIG. 7 describes examples of accelerator acts.

At 601 an instance of single instruction is fetched. For example, an accelerator task instruction is fetched. The instance of the single instruction at least includes fields for an opcode to indicate an operation for an accelerator to perform and identifiers of one or more operands.

Operands may be memory and/or registers. In some examples, the opcode is provided by field 1503, 1112, etc. In some examples, source and/or destination locations are provided by one or more of bits from a prefix 1501 (e.g., R-bit, VVVV, etc.), addressing information 1505 (e.g., reg 1644, R/M 1646, SIB byte 1604, etc.), etc. Additional information such as data element sizes or types may be provided by one or more of the opcode, an immediate, a prefix, etc. In some examples, the opcode indicates the accelerator type to perform the operation.

The fetched instruction of the single instruction is decoded at 603. For example, the fetched accelerator task instruction is decoded by decoder circuitry such as decoder circuitry 301, decode circuitry 1240, etc.

Data values associated with the source operand(s) of the decoded instruction are retrieved when the decoded instruction is scheduled at 605. Note that if the data to be provided to the accelerator is stored in one or more registers of a processor core, that data may be provided directly to the accelerator. In some examples, the data is provided to the accelerator through memory and/or cache. In some examples, the decoded instruction is added to a reservation station for an accelerator at 607.

In some examples, an entry in a reorder buffer of the processor core is updated for the decoded instruction at 609. For example, that the instruction is waiting.

At 611 the decoded instruction is issued through a port of the processor core to the accelerator. In some examples, an entry in a reorder buffer of the processor core is updated for the decoded instruction at 613. For example, that the instruction is issued.

The core waits for a result from the accelerator at 614. Note that this does not mean the core does not perform other tasks. Rather, that the core waits for the port or port slot to receive a result.

A result from the accelerator is received in one or more registers of the core at 615. In some examples, an entry in a reorder buffer of the processor core is updated for the decoded instruction at 617. For example, the entry for the instruction is removed.

In some examples, the instruction is committed or retired at 619.

FIG. 7 illustrates an example method performed by an accelerator to process an instruction from a processor core. For example, an accelerator as shown in FIGS. 1, 3, etc. performs this method. Note that this flow is from the accelerator's perspective only. In some examples, this method is performed while the core waits at 614.

An instruction and/or command is received from a processor at 701. This instruction and/or command includes an indication of the operation to perform (e.g., an opcode) and one or more of information that is used to identify a location of operand data, operand data, and/or an indication of one or more registers to store a result of the operation in the processor core.

In some examples, data for the instruction is accessed at 703. In some examples, the accelerator generates a physical address from addressing information received from the processor and accesses the data at that address. In some examples, the accelerator receives a physical address from the processor and accesses the data at that address. In some examples, the data is stored in a cache of the processor. In some examples, the data is stored in memory coupled to a cache of the processor and to the accelerator. In some examples, the access is performed by a load operation.

One or more operations in accordance with the opcode of the received instruction and/or command is/are performed at 705 using the accelerator.

A result of the one or more operations is transmitted to the processor to be written in one or more registers of the processor at 707.

Some examples utilize instruction formats described herein. Some examples are implemented in one or more computer architectures, cores, accelerators, etc. Some examples are generated or are IP cores. Some examples utilize emulation and/or translation.

### Example Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

### Example Systems

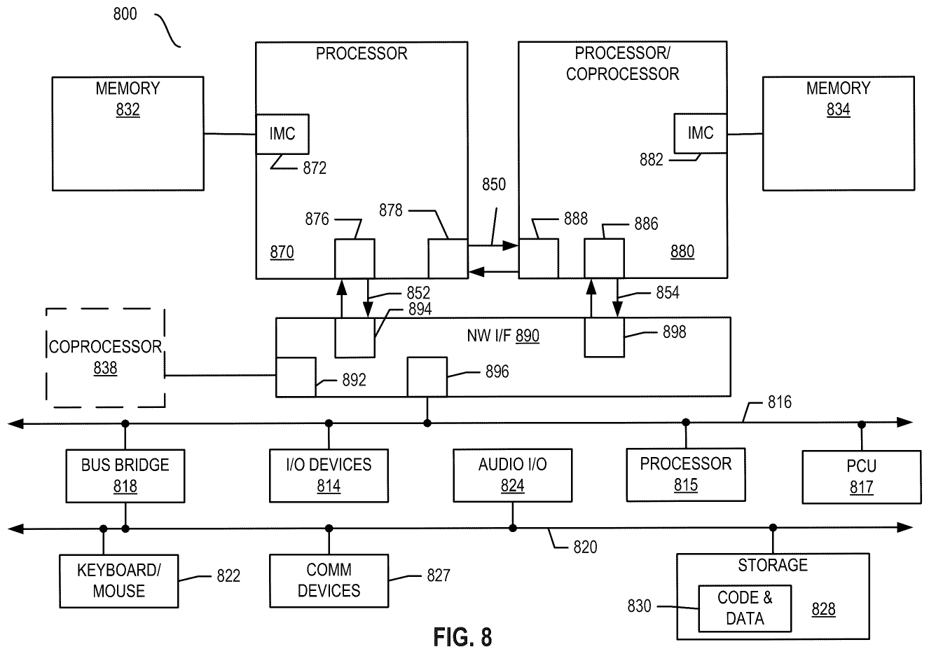

FIG. 8 illustrates an example computing system. Multiprocessor system 800 is an interfaced system and includes a plurality of processors or cores including a first processor 870 and a second processor 880 coupled via an interface 850 such as a point-to-point (P-P) interconnect, a fabric, and/or bus. In some examples, the first processor 870 and the second processor 880 are homogeneous. In some examples, first processor 870 and the second processor 880 are heterogenous. Though the example multiprocessor system 800 is shown to have two processors, the system may have three or more processors, or may be a single processor system. In some examples, the computing system is a system on a chip (SoC).

Processors 870 and 880 are shown including integrated memory controller (IMC) circuitry 872 and 882, respectively. Processor 870 also includes interface circuits 876 and 878; similarly, second processor 880 includes interface circuits 886 and 888. Processors 870, 880 may exchange information via the interface 850 using interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a network interface (NW I/F) 890 via individual interfaces 852, 854 using interface circuits 876, 894, 886, 898. The network interface 890 (e.g., one or more of an interconnect, bus, and/or fabric, and in some examples is a chipset) may optionally exchange information with a co-processor 838 via an interface circuit 892. In some examples, the co-processor 838 is a special-purpose processor, such as, for example, a high-throughput processor, a network or communication processor, a compression engine, a graphics processor, a general purpose graphics processing unit (GPGPU), a neural-network processing unit (NPU), an embedded processor, a security processor, a cryptographic accelerator, a matrix accelerator, an in-memory analytics accelerator, a data streaming accelerator, data graph operations, or the like.

A shared cache (not shown) may be included in either processor 870, 880 or outside of both processors, yet connected with the processors via an interface such as P-P interconnect, such that either or both processors' local cache information may be stored in the shared cache if a processor is placed into a low power mode.

Network interface 890 may be coupled to a first interface 816 via interface circuit 896.

In some examples, first interface 816 may be an interface such as a Peripheral Component Interconnect (PCI) interconnect, a PCI Express interconnect or another I/O interconnect. In some examples, first interface 816 is coupled to a power control unit (PCU) 817, which may include circuitry, software, and/or firmware to perform power management operations with regard to the processors 870, 880 and/or co-processor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interface 816, along with a bus bridge 818 which couples first interface 816 to a second interface 820. In some examples, one or more additional processor(s) 815, such as co-processors, high throughput many integrated core (MIC) processors, GPGPUs, accelerators (such as graphics accelerators or digital signal processing (DSP) units), field programmable gate arrays (FPGAs), or any other processor, are coupled to first interface 816. In some examples, second interface 820 may be a low pin count (LPC) interface.

Various devices may be coupled to second interface 820 including, for example, a keyboard and/or mouse 822, communication devices 827 and storage circuitry 828. Storage circuitry 828 may be one or more non-transitory machine-readable storage media as described below, such as a disk drive or other mass storage device which may include instructions/code and data 830 and may implement the storage 'ISAB03 in some examples. Further, an audio I/O 824 may be coupled to second interface 820. Note that other architectures than the point-to-point architecture described above are possible. For example, instead of the point-to-point architecture, a system such as multiprocessor system 800 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a co-processor including one or more special purpose cores intended primarily for graphics and/or scientific (throughput) computing. Such different processors lead to different computer system architectures, which may include: 1) the co-processor on a separate chip from the CPU; 2) the co-processor on a separate die in the same package as a CPU; 3) the co-processor on the same die as a CPU (in which case, such a co-processor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described co-processor, and additional functionality. Example core architectures are described next, followed by descriptions of example processors and computer architectures.

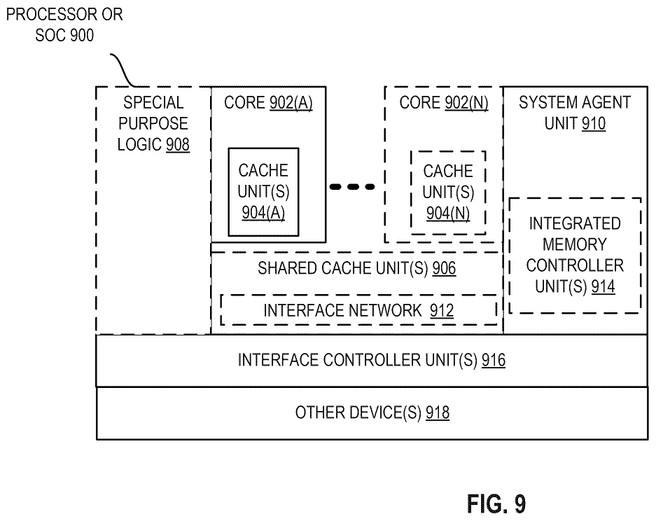

FIG. 9 illustrates a block diagram of an example processor and/or SoC 900 that may have one or more cores and an integrated memory controller. The solid lined boxes illustrate a processor and/or SoC 900 with a single core 902(A), system agent unit circuitry 910, and a set of one or more interface controller unit(s) circuitry 916, while the optional addition of the dashed lined boxes illustrates an alternative processor and/or SoC 900 with multiple cores 902(A)-(N), a set of one or more integrated memory controller unit(s) circuitry 914 in the system agent unit circuitry 910, and special purpose logic 908, as well as a set of one or more interface controller unit(s) circuitry 916. Note that the processor and/or SoC 900 may be one of the processors 870 or 880, or co-processor 838 or 815 of FIG. 8.

Thus, different implementations of the processor and/or SoC 900 may include: 1) a CPU with the special purpose logic 908 being a high-throughput processor, a network or communication processor, a compression engine, a graphics processor, a general purpose graphics processing unit (GPGPU), a neural-network processing unit (NPU), an embedded processor, a security processor, a matrix accelerator, an in-memory analytics accelerator, a compression accelerator, a data streaming accelerator, data graph operations, or the like (which may include one or more cores, not shown), and the cores 902(A)-(N) being one or more general purpose cores (e.g., general purpose in-order cores, general purpose out-of-order cores, or a combination of the two); 2) a co-processor with the cores 902(A)-(N) being a large number of special purpose cores intended primarily for graphics and/or scientific (throughput); and 3) a co-processor with the cores 902(A)-(N) being a large number of general purpose in-order cores.

Thus, the processor and/or SoC 900 may be a general-purpose processor, co-processor or special-purpose processor, such as, for example, a network or communication processor, compression engine, graphics processor, GPGPU (general purpose graphics processing unit), a high throughput many integrated core (MIC) co-processor (including 30 or more cores), embedded processor, or the like. The processor may be implemented on one or more chips. The processor and/or SoC 900 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 904(A)-(N) within the cores 902(A)-(N), a set of one or more shared cache unit(s) circuitry 906, and external memory (not shown) coupled to the set of integrated memory controller unit(s) circuitry 914.

The set of one or more shared cache unit(s) circuitry 906 may include one or more mid-level caches, such as level 2 (L2), level 3 (L3), level 4 (L4), or other levels of cache, such as a last level cache (LLC), and/or combinations thereof. While in some examples interface network circuitry 912 (e.g., a ring interconnect) interfaces the special purpose logic 908 (e.g., integrated graphics logic), the set of shared cache unit(s) circuitry 906, and the system agent unit circuitry 910, alternative examples use any number of well-known techniques for interfacing such units. In some examples, coherency is maintained between one or more of the shared cache unit(s) circuitry 906 and cores 902(A)-(N). In some examples, interface controller unit(s) circuitry 916 couple the cores 902(A)-(N) to one or more other devices 918 such as one or more I/O devices, storage, one or more communication devices (e.g., wireless networking, wired networking, etc.), etc.

In some examples, one or more of the cores 902(A)-(N) are capable of multi-threading.

The system agent unit circuitry 910 includes those components coordinating and operating cores 902(A)-(N). The system agent unit circuitry 910 may include, for example, power control unit (PCU) circuitry and/or display unit circuitry (not shown). The PCU may be or may include logic and components needed for regulating the power state of the cores 902(A)-(N) and/or the special purpose logic 908 (e.g., integrated graphics logic). The display unit circuitry is for driving one or more externally connected displays.

The cores 902(A)-(N) may be homogenous in terms of instruction set architecture (ISA).

Alternatively, the cores 902(A)-(N) may be heterogeneous in terms of ISA; that is, a subset of the cores 902(A)-(N) may be capable of executing an ISA, while other cores may be capable of executing only a subset of that ISA or another ISA.

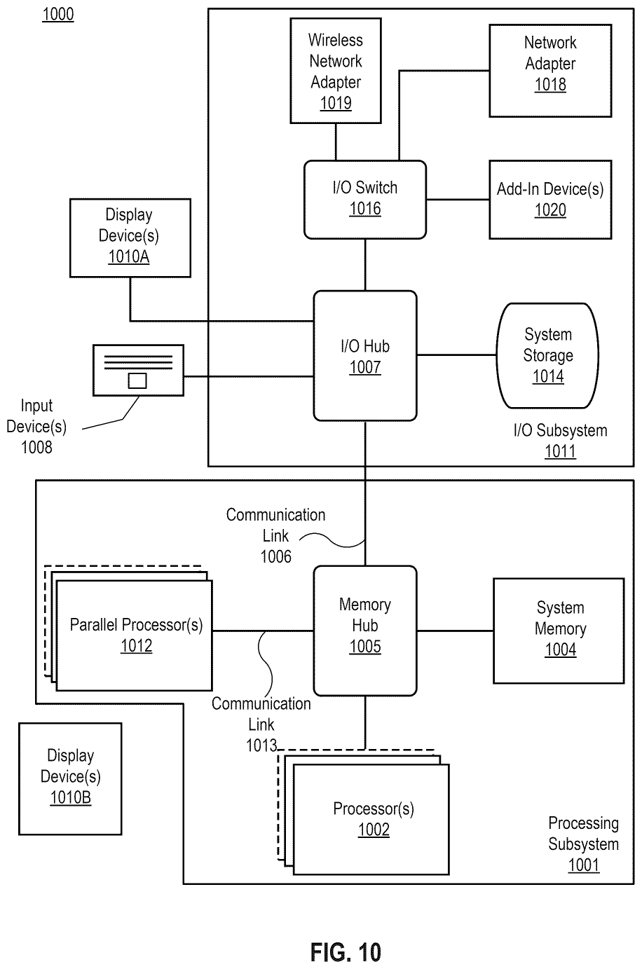

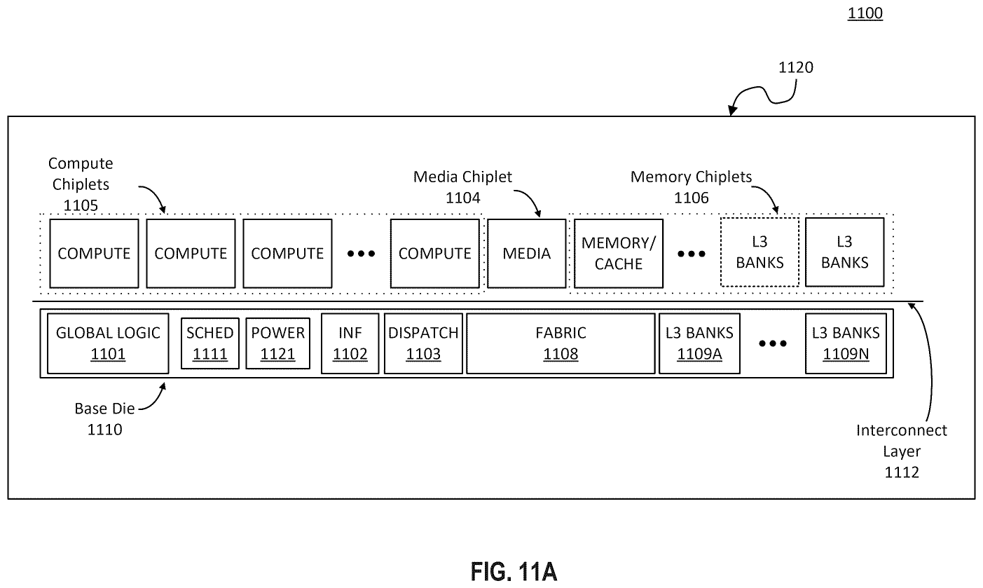

FIG. 10 is a block diagram illustrating a computing system 1000 configured to implement one or more aspects of the examples described herein. The computing system 1000 includes a processing subsystem 1001 having one or more processor(s) 1002 and a system memory 1004 communicating via an interconnection path that may include a memory hub 1005. The memory hub 1005 may be a separate component within a chipset component or may be integrated within the one or more processor(s) 1002. The memory hub 1005 couples with an I/O subsystem 1011 via a communication link 1006. The I/O subsystem 1011 includes an I/O hub 1007 that can enable the computing system 1000 to receive input from one or more input device(s) 1008.

Additionally, the I/O hub 1007 can enable a display controller, which may be included in the one or more processor(s) 1002, to provide outputs to one or more display device(s) 1010A. In some examples the one or more display device(s) 1010A coupled with the I/O hub 1007 can include a local, internal, or embedded display device.

The processing subsystem 1001, for example, includes one or more parallel processor(s) 1012 coupled to memory hub 1005 via a bus or communication link 1013. The communication link 1013 may be one of any number of standards-based communication link technologies or protocols, such as, but not limited to PCI Express, or may be a vendor specific communications interface or communications fabric. The one or more parallel processor(s) 1012 may form a computationally focused parallel or vector processing system that can include a large number of processing cores and/or processing clusters, such as a many integrated core (MIC) processor.

For example, the one or more parallel processor(s) 1012 form a graphics processing subsystem that can output pixels to one of the one or more display device(s) 1010A coupled via the I/O hub 1007. The one or more parallel processor(s) 1012 can also include a display controller and display interface (not shown) to enable a direct connection to one or more display device(s) 1010B.

Within the I/O subsystem 1011, a system storage unit 1014 can connect to the I/O hub 1007 to provide a storage mechanism for the computing system 1000. An I/O switch 1016 can be used to provide an interface mechanism to enable connections between the I/O hub 1007 and other components, such as a network adapter 1018 and/or wireless network adapter 1019 that may be integrated into the platform, and various other devices that can be added via one or more add-in device(s) 1020. The add-in device(s) 1020 may also include, for example, one or more external graphics processor devices, graphics cards, and/or compute accelerators. The network adapter 1018 can be an Ethernet adapter or another wired network adapter. The wireless network adapter 1019 can include one or more of a Wi-Fi, Bluetooth, near field communication (NFC), or other network device that includes one or more wireless radios.

The computing system 1000 can include other components not explicitly shown, including USB or other port connections, optical storage drives, video capture devices, and the like, which may also be connected to the I/O hub 1007. Communication paths interconnecting the various components in FIG. 10 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired orwireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 1012 may incorporate circuitry optimized for graphics and video processing, including, for example, video output circuitry, and constitutes a graphics processing unit (GPU). Alternatively or additionally, the one or more parallel processor(s) 1012 can incorporate circuitry optimized for general purpose processing, while preserving the underlying computational architecture, described in greater detail herein. Components of the computing system 1000 may be integrated with one or more other system elements on a single integrated circuit. For example, the one or more parallel processor(s) 1012, memory hub 1005, processor(s) 1002, and I/O hub 1007 can be integrated into a system on chip (SoC) integrated circuit. Alternatively, the components of the computing system 1000 can be integrated into a single package to form a system in package (SIP) configuration. In some examples at least a portion of the components of the computing system 1000 can be integrated into a multi-chip module (MCM), which can be interconnected with other multi-chip modules into a modular computing system.

It will be appreciated that the computing system 1000 shown herein is illustrative and that variations and modifications are possible. The connection topology, including the number and arrangement of bridges, the number of processor(s) 1002, and the number of parallel processor(s) 1012, may be modified as desired. For instance, system memory 1004 can be connected to the processor(s) 1002 directly rather than through a bridge, while other devices communicate with system memory 1004 via the memory hub 1005 and the processor(s) 1002. In other alternative topologies, the parallel processor(s) 1012 are connected to the I/O hub 1007 or directly to one of the one or more processor(s) 1002, rather than to the memory hub 1005. In other examples, the I/O hub 1007 and memory hub 1005 may be integrated into a single chip. It is also possible that two or more sets of processor(s) 1002 are attached via multiple sockets, which can couple with two or more instances of the parallel processor(s) 1012.

Some of the particular components shown herein are optional and may not be included in all implementations of the computing system 1000. For example, any number of add-in cards or peripherals may be supported, or some components may be eliminated. Furthermore, some architectures may use different terminology for components similar to those illustrated in FIG. 10. For example, the memory hub 1005 may be referred to as a Northbridge in some architectures, while the I/O hub 1007 may be referred to as a Southbridge.

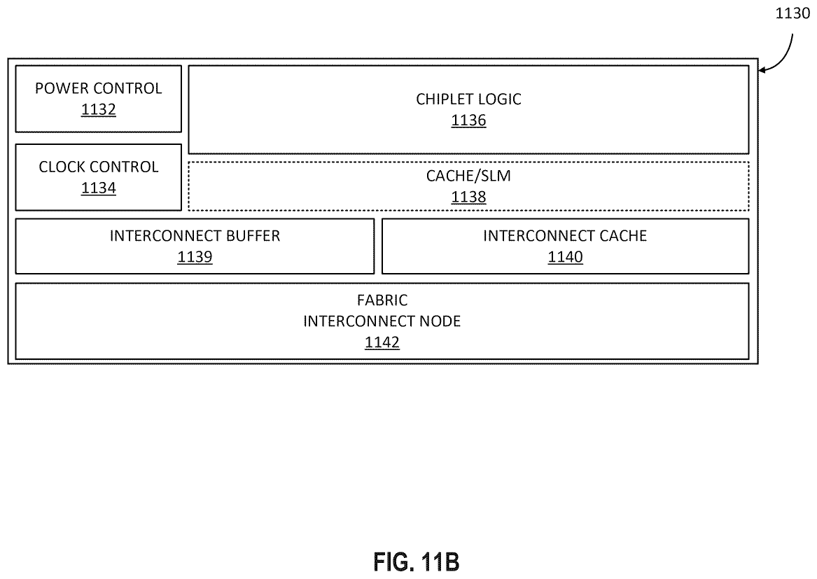

FIGS. 11A-11B illustrate a hybrid logical/physical view of a disaggregated parallel processor, according to examples described herein. FIG. 11A illustrates a disaggregated parallel compute system 1100. FIG. 11B illustrates a chiplet 1130 of the disaggregated parallel compute system 1100.

As shown in FIG. 11A, a disaggregated parallel compute system 1100 can include a parallel processor 1120 in which the various components of the parallel processor SOC are distributed across multiple chiplets. Each chiplet can be a distinct IP core that is independently designed and configured to communicate with other chiplets via one or more common interfaces. The chiplets include but are not limited to compute chiplets 1105, a media chiplet 1104, and memory chiplets 1106. Each chiplet can be separately manufactured using different process technologies. For example, compute chiplets 1105 may be manufactured using the smallest or most advanced process technology available at the time of fabrication, while memory chiplets 1106 or other chiplets (e.g., I/O, networking, etc.) may be manufactured using a larger or less advanced process technologies.

The various chiplets can be bonded to a base die 1110 and configured to communicate with each other and logic within the base die 1110 via an interconnect layer 1112. In some examples, the base die 1110 can include global logic 1101, which can include scheduler 1111 and power management 1121 logic units, an interface 1102, a dispatch unit 1103, and an interconnect fabric 1108 coupled with or integrated with one or more L3 cache banks 1109A-1109N. The interconnect fabric 1108 can be an inter-chiplet fabric that is integrated into the base die 1110. Logic chiplets can use the fabric 1108 to relay messages between the various chiplets. Additionally, L3 cache banks 1109A-1109N in the base die and/or L3 cache banks within the memory chiplets 1106 can cache data read from and transmitted to DRAM chiplets within the memory chiplets 1106 and to system memory of a host.

In some examples the global logic 1101 is a microcontroller that can execute firmware to perform scheduler 1111 and power management 1121 functionality for the parallel processor 1120. The microcontroller that executes the global logic can be tailored for the target use case of the parallel processor 1120. The scheduler 1111 can perform global scheduling operations for the parallel processor 1120. The power management 1121 functionality can be used to enable or disable individual chiplets within the parallel processor when those chiplets are not in use.

The various chiplets of the parallel processor 1120 can be designed to perform specific functionality that, in existing designs, would be integrated into a single die. A set of compute chiplets 1105 can include clusters of compute units (e.g., execution units, streaming multiprocessors, etc.) that include programmable logic to execute compute or graphics shader instructions. A media chiplet 1104 can include hardware logic to accelerate media encode and decode operations. Memory chiplets 1106 can include volatile memory (e.g., DRAM) and one or more SRAM cache memory banks (e.g., L3 banks).

As shown in FIG. 11B, each chiplet 1130 can include common components and application specific components. Chiplet logic 1136 within the chiplet 1130 can include the specific components of the chiplet, such as an array of streaming multiprocessors, compute units, or execution units described herein. The chiplet logic 1136 can couple with an optional cache or shared local memory 1138 or can include a cache or shared local memory within the chiplet logic 1136. The chiplet 1130 can include a fabric interconnect node 1142 that receives commands via the inter-chiplet fabric. Commands and data received via the fabric interconnect node 1142 can be stored temporarily within an interconnect buffer 1139. Data transmitted to and received from the fabric interconnect node 1142 can be stored in an interconnect cache 1140. Power control 1132 and clock control 1134 logic can also be included within the chiplet. The power control 1132 and clock control 1134 logic can receive configuration commands via the fabric can configure dynamic voltage and frequency scaling for the chiplet 1130. In some examples, each chiplet can have an independent clock domain and power domain and can be clock gated and power gated independently of other chiplets.

At least a portion of the components within the illustrated chiplet 1130 can also be included within logic embedded within the base die 1110 of FIG. 11A. For example, logic within the base die that communicates with the fabric can include a version of the fabric interconnect node 1142. Base die logic that can be independently clock or power gated can include a version of the power control 1132 and/or clock control 1134 logic.

Thus, while various examples described herein use the term SOC to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various examples of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).”

Example Core Architectures—in-Order and Out-of-Order Core Block Diagram.

FIG. 12(A) is a block diagram illustrating both an example in-order pipeline and an example register renaming, out-of-order issue/execution pipeline according to examples. FIG. 12(B) is a block diagram illustrating both an example in-order architecture core and an example register renaming, out-of-order issue/execution architecture core to be included in a processor according to examples. The solid lined boxes in FIGS. 12(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 12(A), a processor pipeline 1200 includes a fetch stage 1202, an optional length decoding stage 1204, a decode stage 1206, an optional allocation (Alloc) stage 1208, an optional renaming stage 1210, a schedule (also known as a dispatch or issue) stage 1212, an optional register read/memory read stage 1214, an execute stage 1216, a write back/memory write stage 1218, an optional exception handling stage 1222, and an optional commit stage 1224. One or more operations can be performed in each of these processor pipeline stages. For example, during the fetch stage 1202, one or more instructions are fetched from instruction memory, and during the decode stage 1206, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 1206 and the register read/memory read stage 1214 may be combined into one pipeline stage. In some examples, during the execute stage 1216, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 12(B) may implement the pipeline 1200 as follows: 1) the instruction fetch circuitry 1238 performs the fetch and length decoding stages 1202 and 1204; 2) the decode circuitry 1240 performs the decode stage 1206; 3) the rename/allocator unit circuitry 1252 performs the allocation stage 1208 and renaming stage 1210; 4) the scheduler(s) circuitry 1256 performs the schedule stage 1212; 5) the physical register file(s) circuitry 1258 and the memory unit circuitry 1270 perform the register read/memory read stage 1214; the execution cluster(s) 1260 perform the execute stage 1216; 6) the memory unit circuitry 1270 and the physical register file(s) circuitry 1258 perform the write back/memory write stage 1218; 7) various circuitry may be involved in the exception handling stage 1222; and 8) the retirement unit circuitry 1254 and the physical register file(s) circuitry 1258 perform the commit stage 1224.

FIG. 12(B) shows a processor core 1290 including front-end unit circuitry 1230 coupled to execution engine unit circuitry 1250, and both are coupled to memory unit circuitry 1270. The core 1290 may be a reduced instruction set architecture computing (RISC) core, a complex instruction set architecture computing (CISC) core, a very long instruction word (VLIW) core, or a hybrid or alternative core type. As yet another option, the core 1290 may be a special-purpose core, such as, for example, a network or communication core, compression engine, co-processor core, general purpose computing graphics processing unit (GPGPU) core, graphics core, or the like.

The front-end unit circuitry 1230 may include branch prediction circuitry 1232 coupled to instruction cache circuitry 1234, which is coupled to an instruction translation lookaside buffer (TLB) 1236, which is coupled to instruction fetch circuitry 1238, which is coupled to decode circuitry 1240. In some examples, the instruction cache circuitry 1234 is included in the memory unit circuitry 1270 rather than the front-end unit circuitry 1230. The decode circuitry 1240 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1240 may further include address generation unit (AGU, not shown) circuitry.

In some examples, the AGU generates an LSU address using forwarded register ports, and may further perform branch forwarding (e.g., immediate offset branch forwarding, LR register branch forwarding, etc.). The decode circuitry 1240 may be implemented using various different mechanisms. Examples of suitable mechanisms include, but are not limited to, look-up tables, hardware implementations, programmable logic arrays (PLAs), microcode read only memories (ROMs), etc. In some examples, the core 1290 includes a microcode ROM (not shown) or other medium that stores microcode for certain macroinstructions (e.g., in decode circuitry 1240 or otherwise within the front-end unit circuitry 1230). In some examples, the decode circuitry 1240 includes a micro-operation (micro-op) or operation cache (not shown) to hold/cache decoded operations, micro-tags, or micro-operations generated during the decode or other stages of the processor pipeline 1200. The decode circuitry 1240 may be coupled to rename/allocator unit circuitry 1252 in the execution engine unit circuitry 1250.

The execution engine unit circuitry 1250 includes the rename/allocator unit circuitry 1252 coupled to retirement unit circuitry 1254 and a set of one or more scheduler(s) circuitry 1256. The scheduler(s) circuitry 1256 represents any number of different schedulers, including reservations stations, central instruction window, etc. In some examples, the scheduler(s) circuitry 1256 can include arithmetic logic unit (ALU) scheduler/scheduling circuitry, ALU queues, address generation unit (AGU) scheduler/scheduling circuitry, AGU queues, etc. The scheduler(s) circuitry 1256 is coupled to the physical register file(s) circuitry 1258. Each of the physical register file(s) circuitry 1258 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 1258 includes vector registers unit circuitry, writemask registers unit circuitry, and scalar register unit circuitry. These register units may provide architectural vector registers, vector mask registers, general-purpose registers, etc. The physical register file(s) circuitry 1258 is coupled to the retirement unit circuitry 1254 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1254 and the physical register file(s) circuitry 1258 are coupled to the execution cluster(s) 1260. The execution cluster(s) 1260 includes a set of one or more execution unit(s) circuitry 1262 and a set of one or more memory access circuitry 1264. The execution unit(s) circuitry 1262 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). In some examples, execution unit(s) circuitry 1262 may include hardware to support functionality for instructions for one or more of a compression engine, graphics processing, neural-network processing, in-memory analytics, matrix operations, cryptographic operations, data streaming operations, data graph operations, etc.

While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1256, physical register file(s) circuitry 1258, and execution cluster(s) 1260 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1264). It should also be understood that where separate pipelines are used, one or more of these pipelines may be out-of-order issue/execution and the rest in-order.

In some examples, the execution engine unit circuitry 1250 may perform load store unit (LSU) address/data pipelining to an Advanced Microcontroller Bus (AMB) interface (not shown), and address phase and writeback, data phase load, store, and branches.

The set of memory access circuitry 1264 is coupled to the memory unit circuitry 1270, which includes data TLB circuitry 1272 coupled to data cache circuitry 1274 coupled to level 2 (L2) cache circuitry 1276. In some examples, the memory access circuitry 1264 may include load unit circuitry, store address unit circuitry, and store data unit circuitry, each of which is coupled to the data TLB circuitry 1272 in the memory unit circuitry 1270. The instruction cache circuitry 1234 is further coupled to the level 2 (L2) cache circuitry 1276 in the memory unit circuitry 1270.

In some examples, the instruction cache 1234 and the data cache 1274 are combined into a single instruction and data cache (not shown) in L2 cache circuitry 1276, level 3 (L3) cache circuitry (not shown), and/or main memory. The L2 cache circuitry 1276 is coupled to one or more other levels of cache and eventually to a main memory.

The core 1290 may support one or more instructions sets (e.g., the x86 instruction set architecture (optionally with some extensions that have been added with newer versions); the MIPS instruction set architecture; the ARM instruction set architecture (optionally with optional additional extensions such as NEON, etc.); RISC instruction set architecture), including the instruction(s) described herein. In some examples, the core 1290 includes logic to support a packed data instruction set architecture extension (e.g., AVX1, AVX2, AVX512, AMX, etc.), thereby allowing the operations used by many multimedia applications to be performed using packed data.

### Example Execution Unit(s) Circuitry.

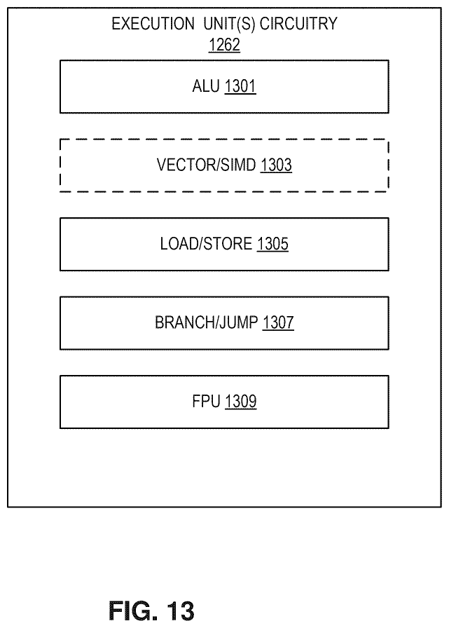

FIG. 13 illustrates examples of execution unit(s) circuitry, such as execution unit(s) circuitry 1262 of FIG. 12(B). As illustrated, execution unit(s) circuitry 1262 may include one or more ALU circuits 1301, optional vector/single instruction multiple data (SIMD) circuits 1303, load/store circuits 1305, branch/jump circuits 1307, and/or Floating-point unit (FPU) circuits 1309. ALU circuits 1301 perform integer arithmetic and/or Boolean operations. Vector/SIMD circuits 1303 perform vector/SIMD operations on packed data (such as SIMD/vector registers).

Load/store circuits 1305 execute load and store instructions to load data from memory into registers or store from registers to memory. Load/store circuits 1305 may also generate addresses. Branch/jump circuits 1307 cause a branch or jump to a memory address depending on the instruction. FPU circuits 1309 perform floating-point arithmetic. The width of the execution unit(s) circuitry 1262 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

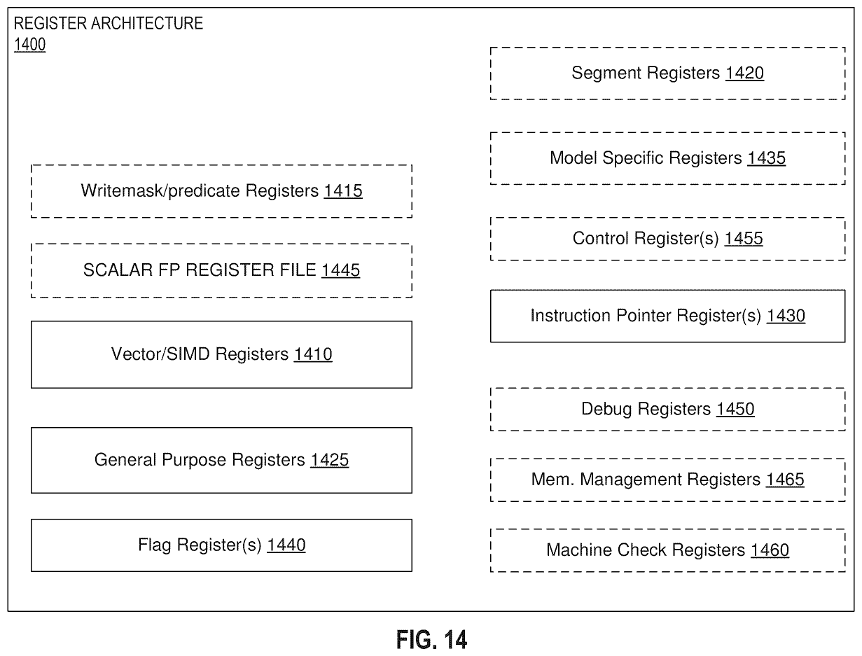

FIG. 14 is a block diagram of a register architecture 1400 according to some examples. As illustrated, the register architecture 1400 includes vector/SIMD registers 1410 that vary from 128-bit to 1,024 bits width. In some examples, the vector/SIMD registers 1410 are physically 512-bits and, depending upon the mapping, only some of the lower bits are used. For example, in some examples, the vector/SIMD registers 1410 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1400 includes writemask/predicate registers 1415. For example, in some examples, there are 8 writemask/predicate registers (sometimes called k0 through k7) that are each 16-bit, 32-bit, 64-bit, or 128-bit in size. Writemask/predicate registers 1415 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1415 corresponds to a data element position of the destination. In other examples, the writemask/predicate registers 1415 are scalable and consists of a set number of enable bits for a given vector element (e.g., 8 enable bits per 64-bit vector element).

The register architecture 1400 includes a plurality of general-purpose registers 1425. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1400 includes scalar floating-point (FP) registerfile 1445 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1440 (e.g., EFLAGS, RFLAGS, etc.) store status and control information for arithmetic, compare, and system operations. For example, the one or more flag registers 1440 may store condition code information such as carry, parity, auxiliary carry, zero, sign, and overflow. In some examples, the one or more flag registers 1440 are called program status and control registers.

Segment registers 1420 contain segment points for use in accessing memory. In some examples, these registers are referenced by the names CS, DS, SS, ES, FS, and GS.

Model specific registers or machine specific registers (MSRs) 1435 control and report on processor performance. Most MSRs 1435 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 1460 consist of control, status, and error reporting MSRs that are used to detect and report on hardware errors. Control register(s) 1455 (e.g., CR0-CR4) determine the operating mode of a processor (e.g., processor 870, 880, 838, 815, and/or 900) and the characteristics of a currently executing task. In some examples, MSRs 1435 are a subset of control registers 1455.

One or more instruction pointer register(s) 1430 store an instruction pointer value. Debug registers 1450 control and allow for the monitoring of a processor or core's debugging operations.

Memory (mem) management registers 1465 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1400 may, for example, be used in register file/memory 'ISAB08, or physical register file(s) circuitry 12 58.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats.

Additionally, example systems, architectures, and pipelines are detailed below. Examples of the instruction(s) may be executed on such systems, architectures, and pipelines, but are not limited to those detailed.

FIG. 15 illustrates examples of an instruction format. As illustrated, an instruction may include multiple components including, but not limited to, one or more fields for: one or more prefixes, an opcode, addressing information (e.g., register identifiers, memory addressing information, etc.), a displacement value, and/or an immediate value. Note that some instructions utilize some or all the fields of the format whereas others may only use the field for the opcode 1503. In some examples, the order illustrated is the order in which these fields are to be encoded, however, it should be appreciated that in other examples these fields may be encoded in a different order, combined, etc.

The prefix(es) f 1501, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1503 is used to at least partially define the operation to be performed upon a decoding of the instruction. In some examples, a primary opcode encoded in the opcode field 1503 is one, two, or three bytes in length. In other examples, a primary opcode can be a different length. An additional 3-bit opcode field is sometimes encoded in another field.

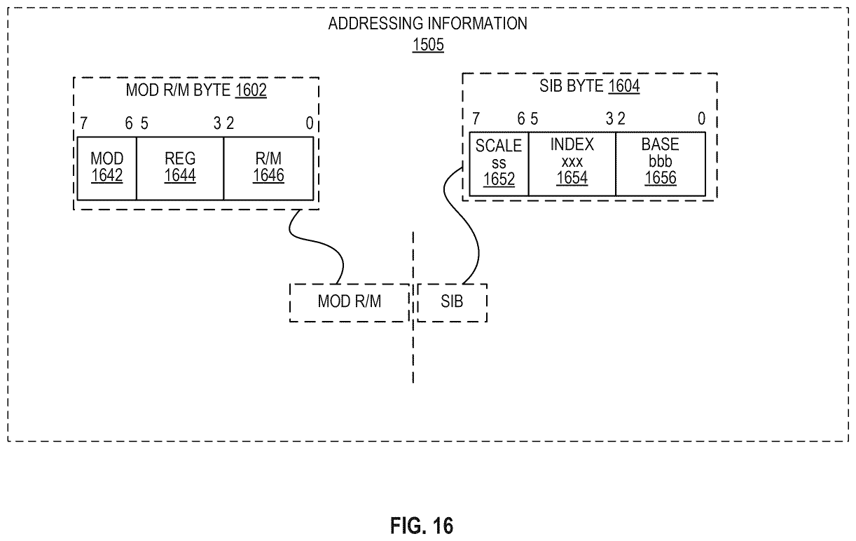

The addressing information field 1505 is used to address one or more operands of the instruction, such as a location in memory or one or more registers. FIG. 16 illustrates examples of the addressing information field 1505. In this illustration, an optional MOD R/M byte 1602 and an optional Scale, Index, Base (SIB) byte 1604 are shown. The MOD R/M byte 1602 and the SIB byte 1604 are used to encode up to two operands of an instruction, each of which is a direct register or effective memory address. Note that both of these fields are optional in that not all instructions include one or more of these fields. The MOD R/M byte 1602 includes a MOD field 1642, a register (reg) field 1644, and R/M field 1646.

The content of the MOD field 1642 distinguishes between memory access and non-memory access modes. In some examples, when the MOD field 1642 has a binary value of 11 (11b), a register-direct addressing mode is utilized, and otherwise a register-indirect addressing mode is used.

The register field 1644 may encode either the destination register operand or a source register operand or may encode an opcode extension and not be used to encode any instruction operand. The content of register field 1644, directly or through address generation, specifies the locations of a source or destination operand (either in a register or in memory). In some examples, the register field 1644 is supplemented with an additional bit from a prefix (e.g., prefix 1501) to allow for greater addressing.

The R/M field 1646 may be used to encode an instruction operand that references a memory address or may be used to encode either the destination register operand or a source register operand. Note the R/M field 1646 may be combined with the MOD field 1642 to dictate an addressing mode in some examples.

The SIB byte 1604 includes a scale field 1652, an index field 1654, and a base field 1656 to be used in the generation of an address. The scale field 1652 indicates a scaling factor. The index field 1654 specifies an index register to use. In some examples, the index field 1654 is supplemented with an additional bit from a prefix (e.g., prefix 1501) to allow for greater addressing. The base field 1656 specifies a base register to use. In some examples, the base field 1656 is supplemented with an additional bit from a prefix (e.g., prefix 1501) to allow for greater addressing. In practice, the content of the scale field 1652 allows for the scaling of the content of the index field 1654 for memory address generation (e.g., for address generation that uses 2^{scale}*index+base).

Some addressing forms utilize a displacement value to generate a memory address.

For example, a memory address may be generated according to 2_{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1507 provides this value. Additionally, in some examples, a displacement factor usage is encoded in the MOD field of the addressing information field 1505 that indicates a compressed displacement scheme for which a displacement value is calculated and stored in the displacement field 1507.

In some examples, the immediate value field 1509 specifies an immediate value for the instruction. An immediate value may be encoded as a 1-byte value, a 2-byte value, a 4-byte value, etc.

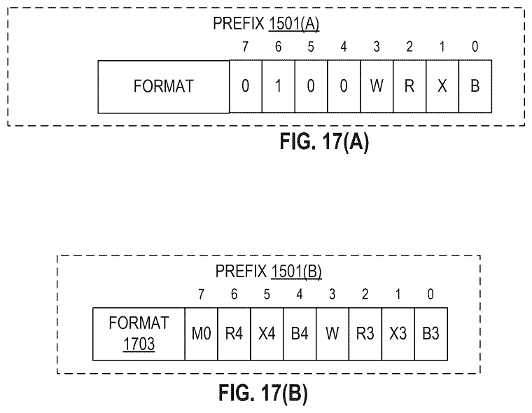

FIGS. 17(A)-(B) illustrates examples of a first prefix 1501(A). FIG. 17(A) illustrates first examples of the first prefix 1501(A). In some examples, the first prefix 1501(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1501(A) may specify up to three registers using 3-bit fields depending on the format: 1) using the reg field 1644 and the R/M field 1646 of the MOD R/M byte 1602; 2) using the MOD R/M byte 1602 with the SIB byte 1604 including using the reg field 1644 and the base field 1656 and index field 1654; or 3) using the register field of an opcode.

In the first prefix 1501(A), bit positions of the payload byte 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1644 and MOD R/M R/M field 1646 alone can each only address 8 registers.

In the first prefix 1501(A), bit position 2 (R) may be an extension of the MOD R/M reg field 1644 and may be used to modify the MOD R/M reg field 1644 when that field encodes a general-purpose register, a 64-bit packed data register (e.g., a SSE register), or a control or debug register. R is ignored when MOD R/M byte 1602 specifies other registers or defines an extended opcode.

Bit position 1 (X) may modify the SIB byte index field 1654.

Bit position 0 (B) may modify the base in the MOD R/M R/M field 1646 or the SIB byte base field 1656; or it may modify the opcode register field used for accessing general purpose registers (e.g., general purpose registers 1425).

FIG. 17(B) illustrates second examples of the first prefix 1501(A). In some examples, the prefix 1501(A) supports addressing 32 general purpose registers. In some examples, this prefix is called REX2.

In some examples, one or more of instructions for increment, decrement, negation, addition, subtraction, AND, OR, XOR, shift arithmetically left, shift logically left, shift arithmetically right, shift logically right, rotate left, rotate right, multiply, divide, population count, leading zero count, total zero count, etc. support flag suppression.

In some examples, one or more of instructions for increment, decrement, NOT, negation, addition, add with carry, integer subtraction with borrow, subtraction, AND, OR, XOR, shift arithmetically left, shift logically left, shift arithmetically right, shift logically right, rotate left, rotate right, multiply, divide, population count, leading zero count, total zero count, unsinged integer addition of two operands with carry flag, unsinged integer addition of two operands with overflow flag, conditional move, pop, push, etc. support REX2.

As shown, REX2 has a format field 1703 in a first byte and 8 bits in a second byte (e.g., a payload byte). In some examples, the format field 1703 has a value of 0xD5. In some examples, 0xD5 encodes an ASCIII Adjust AX Before Division (AAD) instruction in a 32-bit mode. In those examples, in a 64-bit mode it is used as the first byte of the prefix of FIG. 17(B).

The payload byte includes several bits.

Bit position 0 (B3) may modify the base in the MOD R/M R/M field 1646 or the SIB byte base field 1656; or it may modify the opcode register field used for accessing general purpose registers (e.g., general purpose registers 1425).

Bit position 1 (X3) may modify the SIB byte index field 1654.

Bit position 2 (R3) may be used as an extension of the MOD R/M reg field 1644 and may be used to modify the MOD R/M reg field 1644 when that field encodes a general-purpose register, a 64-bit packed data register (e.g., an SSE register), or a control or debug register. R3 may be ignored when MOD R/M byte 1602 specifies other registers or defines an extended opcode.

Bit position 3 (W) can be used to determine an operand size, but may not solely determine operand width. As such, when W=0, the operand size is determined by a code segment descriptor (CS.D) and when W=1, the operand size is 64-bit.

Bit position 4 (B4) may further (along with B3) modify the base in the MOD R/M R/M field 1646 or the SIB byte base field 1656; or it may modify the opcode register field used for accessing general purpose registers (e.g., general purpose registers 1425).

Bit position 5 (X4) may further (along with X3) modify the SIB byte index field 1654.

Bit position 6 (R4) may further (along with R3) be used as an extension of the MOD R/M reg field 1644 and may be used to modify the MOD R/M reg field 1644 when that field encodes a general-purpose register, a 64-bit packed data register (e.g., an SSE register), or a control or debug register.

In some examples, bit position 7 (M0) indicates an opcode map (e.g., 0 or 1).

R3, R4, X3, X4, B3, and B4 allow for the addressing of 32 GPRs. That is an R, X or B register identifier is extended by the R3, X3, and B3 and R4, X4, and B4 bits in a REX2 prefix when and only when it encodes a GPR register. In some examples, the vector (or any other type of) registers are not encoded using those bits.

In some examples, REX2 must be the last prefix and the byte following it is interpreted as the main opcode byte in the opcode map indicated by M0. The 0x0F escape byte is neither needed nor allowed. In some examples, prefixes which may precede the REX2 prefix are LOCK (0xF0), REPE/REP/REPZ (0xF3), REPNE/REPNZ (0xF2), operand-size override (0x66), address-size override (0x67), and segment overrides.

In general, when any of the bits in REX2 R4, X4, B4, R3, X3, and B3 are not used they are ignored. For example, when there is no index register, X4 and X3 are both ignored. Similarly, when the R, X, or B register identifier encodes a vector register, the R4, X4, or B4 bit is ignored. There are, however, in some examples, one or two exceptions to this general rule: 1) an attempt to access a non-existent control register or debug register will trigger #UD and 2) instructions with opcodes 0x50-0x5F (including POP and PUSH) use R4 to encode a push-pop acceleration hint.

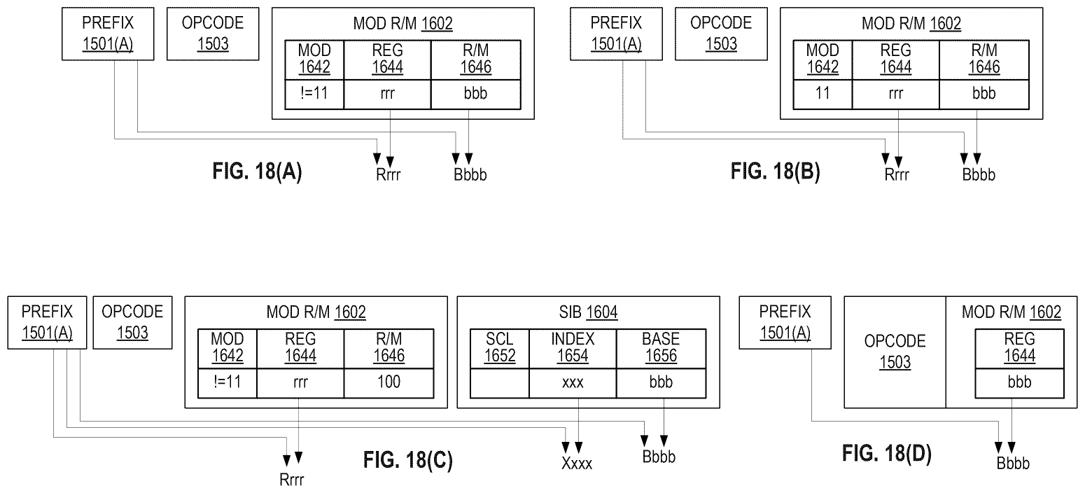

FIGS. 18(A)-(D) illustrate examples of how the R, X, and B fields of the first prefix 1501(A) are used. FIG. 18(A) illustrates R and B from the first prefix 1501(A) being used to extend the reg field 1644 and R/M field 1646 of the MOD R/M byte 1602 when the SIB byte 1604 is not used for memory addressing. FIG. 18(B) illustrates R and B from the first prefix 1501(A) being used to extend the reg field 1644 and R/M field 1646 of the MOD R/M byte 1602 when the SIB byte 1604 is not used (register-register addressing). FIG. 18(C) illustrates R, X, and B from the first prefix 1501(A) being used to extend the reg field 1644 of the MOD R/M byte 1602 and the index field 1654 and base field 1656 when the SIB byte 1604 being used for memory addressing. FIG. 18(D) illustrates B from the first prefix 1501(A) being used to extend the reg field 1644 of the MOD R/M byte 1602 when a register is encoded in the opcode 1503. The R4 and R3 values of FIG. 17(B) can be used to expand rrr, B4 and B3 can be used to expand bbb, and X4 and X3 can be used to expand xxx.

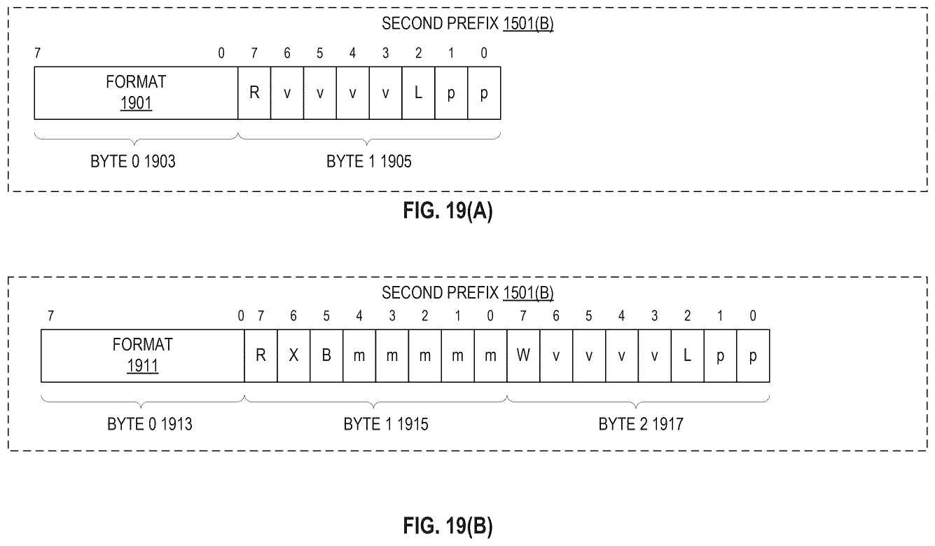

FIGS. 19(A)-(B) illustrate examples of a second prefix 1501(B). In some examples, the second prefix 1501(B) is an example of a VEX prefix. The second prefix 1501(B) encoding allows instructions to have more than two operands, and allows SIMD vector registers (e.g., vector/SIMD registers 1410) to be longer than 64-bits (e.g., 128-bit and 256-bit). The use of the second prefix 1501(B) provides for three-operand (or more) syntax. For example, previous two-operand instructions performed operations such as A=A+B, which overwrites a source operand. The use of the second prefix 1501(B) enables operands to perform nondestructive operations such as A=B+C.

In some examples, the second prefix 1501(B) comes in two forms—a two-byte form and a three-byte form. The two-byte second prefix 1501(B) is used mainly for 128-bit, scalar, and some 256-bit instructions; while the three-byte second prefix 1501(B) provides a compact replacement of the first prefix 1501(A) and 3-byte opcode instructions.

FIG. 19(A) illustrates examples of a two-byte form of the second prefix 1501(B). In some examples, a format field 1901 (byte 0 1903) contains the value C5H. In some examples, byte 11905 includes an “R” value in bit[7]. This value is the complement of the “R” value of the first prefix 1501(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1646 to encode the instruction operand that references a memory address or encode either the destination register operand or a source register operand.

Instructions that use this prefix may use the MOD R/M reg field 1644 to encode either the destination register operand or a source register operand, or to be treated as an opcode extension and not used to encode any instruction operand.

For instruction syntax that support four operands, vvvv, the MOD R/M R/M field 1646 and the MOD R/M reg field 1644 encode three of the four operands. Bits[7:4] of the immediate value field 1509 are then used to encode the third source register operand.

FIG. 19(B) illustrates examples of a three-byte form of the second prefix 1501(B). In some examples, a format field 1911 (byte 0 1913) contains the value C4H. Byte 1 1915 includes in bits[7:5] “R,” “X,” and “B” which are the complements of the same values of the first prefix 1501(A). Bits[4:0] of byte 1 1915 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 1917 is used similar to W of the first prefix 1501(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1646 to encode the instruction operand that references a memory address or encode either the destination register operand or a source register operand.

Instructions that use this prefix may use the MOD R/M reg field 1644 to encode either the destination register operand or a source register operand, or to be treated as an opcode extension and not used to encode any instruction operand.

For instruction syntax that support four operands, vvvv, the MOD R/M R/M field 1646, and the MOD R/M reg field 1644 encode three of the four operands. Bits[7:4] of the immediate value field 1509 are then used to encode the third source register operand.

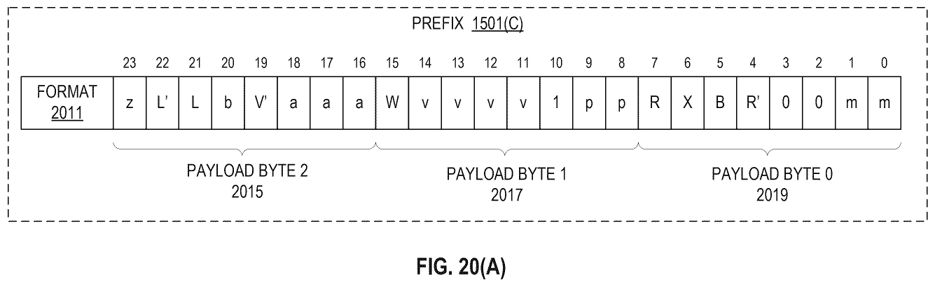

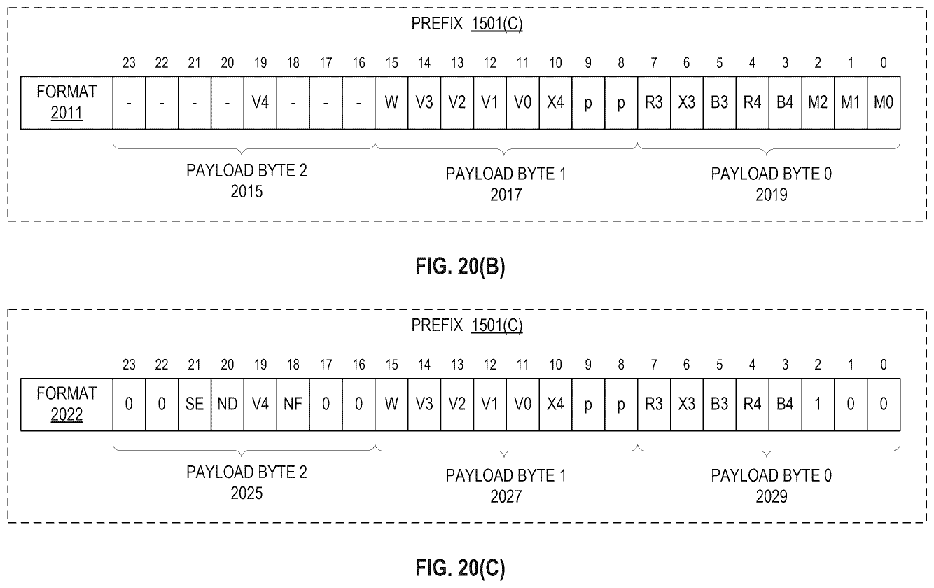

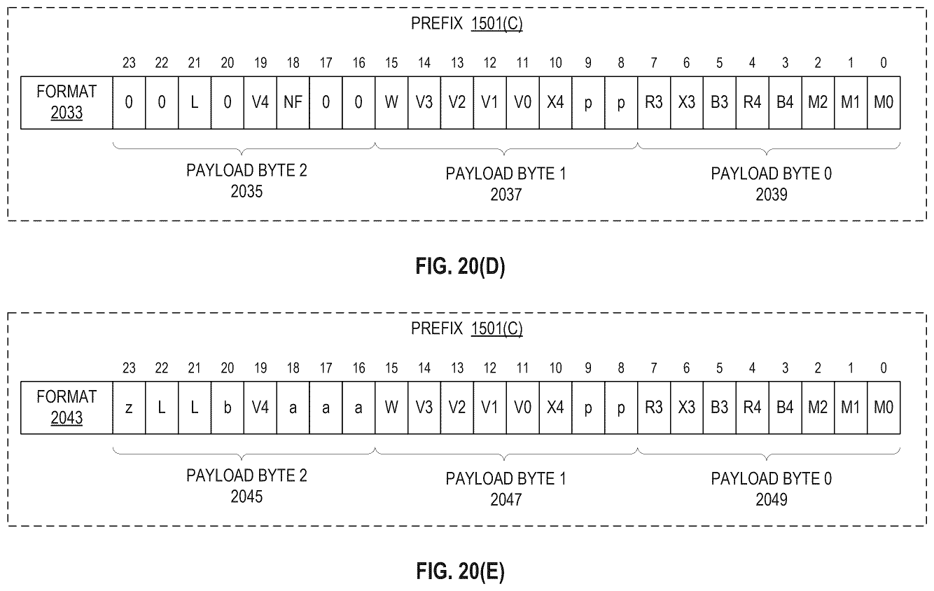

FIGS. 20(A)-(E) illustrates examples of a third prefix 1501(C). FIG. 20(A) illustrates first examples of the third prefix. In some examples, the third prefix 1501(C) is an example of an EVEX prefix. The third prefix 1501(C) is a four-byte prefix.

The third prefix 1501(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 14) or predication utilize this prefix. Opmask register allow for conditional processing or selection control. Opmask instructions, whose source/destination operands are opmask registers and treat the content of an opmask register as a single value, are encoded using the second prefix 1501(B).

The third prefix 1501(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1501(C) is a format field 2011 that has a value, in some examples, of 62H. Subsequent bytes are referred to as payload bytes 2015-2019 and collectively form a 24-bit value of P[23:0] providing specific capability in the form of one or more fields (detailed herein).

In some examples, P[1:0] of payload byte 2019 are identical to the low two mm bits. P[3:2] are reserved in some examples. Bit P[4] (R′) allows access to the high 16 vector register set when combined with P[7] and the MOD R/M reg field 1644. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1644 and MOD R/M R/M field 1646. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 1501(A) and second prefix 1511(B) and may serve as an opcode extension bit or operand size promotion.

P[18:16] specify the index of a register in the opmask (writemask) registers (e.g., writemask/predicate registers 1415). In some examples, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other some examples, preserving the old value of each element of the destination where the corresponding mask bit has a 0. In contrast, when zeroing vector masks allow any set of elements in the destination to be zeroed during the execution of any operation (specified by the base operation and the augmentation operation); in some examples, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differ across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1501(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination |
| | | | reg | | or Source |
| VVVV | V′ | vvvv | | GPR, Vector | 2nd Source or |
| | | | | | Destination |
| RM | X | B | MOD R/M | GPR, Vector | 1st Source or |
| | | | R/M | | Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

FIG. 20(B) illustrates second examples of the third prefix. In some examples, the prefix 16K01(B) is an example of an EVEX2 prefix. The EVEX2 prefix 1501(C) is a four-byte prefix.

In some examples, one or more of instructions for increment, decrement, NOT, negation, addition, add with carry, integer subtraction with borrow, subtraction, AND, OR, XOR, shift arithmetically left, shift logically left, shift arithmetically right, shift logically right, rotate left, rotate right, multiply, divide, population count, pop, push, leading zero count, total zero count, unsinged integer addition of two operands with carry flag, unsinged integer addition of two operands with overflow flag, conditional move, etc. support EVEX2.

For these instructions there it should be noted that NDD may or may not be used depending on the settings of the prefix of those instructions.

The extended EVEX prefix is an extension of a 4-byte EVEX prefix and is used to provide APX features for legacy instructions which cannot be provided by the REX2 prefix (in particular, the new data destination) and APX extensions of VEX and EVEX instructions. Most bits in the third payload byte (except for the V4 bit) are left unspecified because the payload bit assignment depends on whether the EVEX prefix is used to provide APX extension to a legacy, VEX, or EVEX instruction, the details of which will be given in the subsections below. The byte following the extended EVEX prefix is always interpreted as the main opcode byte. Escape sequences 0x0F, 0x0F38 and 0x0F3A are neither needed nor allowed.

The EVEX2 prefix 1501(B) can encode 32 vector registers (e.g., 128-bit, 256-bit, and 512-bit registers) in 64-bit mode and/or 32 general purpose registers.

The EVEX2 prefix 1501(B) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the EVEX2 prefix 1501(B) is a format field 1511 that has a value, in some examples, of 0x62. Subsequent bytes are referred to as payload bytes 1515-1519 and collectively form a 24-bit value of P[23:0] providing specific capability in the form of one or more fields (detailed herein).

Bits 0:2 (M0, M1, and M2) of a first payload byte (payload byte 0) 2017 are used to provide an opcode map identification. Note that this is limited to 8 maps.

Bit 3 (B4) provides the fifth bit and most significant bit for the B register identifier.

Bit 4 (R4) provides the fifth bit and most significant bit for the R register identifier.

Bit 5 (B3), bit 6 (X3), and bit 7 (R3) provide the fourth bit for the B, X, and R register identifiers respectively when combined with a MOD R/M register field (R register), a MOD R/M R/M field (B register), and/or a SIB.INDEX field (X register).

Bits 9:8 provide opcode extensionality equivalent to some legacy prefixes (e.g., 00=no prefix, 01=66H, 10=F3H, and 11=F2H).

Bit 10 (X4) provides the fifth bit and most significant bit for the X register identifier.

Bits 14:11, shown as V3V2V1V0 may be used to: 1) encode the first source register operand, specified in inverted (1s complement) form and valid for instructions with 2 or more source operands; 2) encode a new data destination register operand, specified in 1s complement form for certain vector shifts; or 3) not encode any operand, the field is reserved and should contain a certain value, such as 1111b.

Bit 15 (W) may serve as an opcode extension bit or operand size promotion.

Bit 19 can be combined with bits 14:11 to encode a register in a new data destination.

In some examples, R3, R4, B3, X3, X4, V3, V2, V1, V0 are inverted. In some examples, B4 and X5 are repurposed reserved bits of an existing prefix that are used to provide the fifth and most significant bits of the B and X register identifiers. Their polarities are chosen so that the current fixed values at those two locations encode logical 0 after the repurposing. (In other words, the current fixed value at B4 is 0 and that at X4 is 1.)

Example examples of source and/or destination encoding in instructions using the EVEX2 prefix 1501(C) are detailed in the following table.

| | 4 | 3 | [2:0] | REG. TYPE | COMMON USAGES |
|---|---|---|---|---|---|
| R | R4 | R3 | MOD R/M | GPR | Destination |
| register | | | reg | | or Source |
| B | B4 | B3 | MOD R/M | GPR | Destination |
| register | | | reg | | or Source |
| V | V4 | V3V2V1V0 | | GPR | 2nd Source |
| register | | | | | or Destination |
| RM | B4 | B3 | MOD R/M | GPR | 1st Source |
| | | | R/M | | or Destination |
| BASE | B4 | B3 | MOD R/M | GPR | Memory addressing |
| | | | R/M | | |
| INDEX | X4 | X3 | SIB.index | GPR | Memory addressing |

FIG. 20(C) illustrates third examples of the third prefix. In some examples, the prefix 1501(C) is an example of an EVEX2 prefix. The EVEX2 prefix 1501(C) is a four-byte prefix.

The EVEX2 prefix 1501(C) can encode at least 32 vector registers (e.g., 128-bit, 256-bit, and 512-bit registers) in 64-bit mode and/or up to 64 general purpose registers.

The EVEX2 prefix 1501(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the EVEX2 prefix 1501(C) is a format field 2022 that has a value, in one example, of 0x62. Subsequent bytes are referred to as payload bytes 555-2029 and collectively form a 24-bit value of P[23:0] providing specific capability in the form of one or more fields (detailed herein).

Bits 0:1 are set to zero and bit 2 is set to 1.

Bit 3 (B4) provides the fifth bit and most significant bit for the B register identifier.

Bit 4 (R4) provides the fifth bit and most significant bit for the R register identifier.

Bit 5 (B3), bit 6 (X3), and bit 7 (R3) provide the fourth bit for the B, X, and R register identifiers respectively when combined with a MOD R/M register field (R register), a MOD R/M R/M field (B register), and/or a SIB.INDEX field (X register).

Bits 9:8 provide opcode extensionality equivalent to some legacy prefixes (e.g., 00=no prefix, 01=66H, 10=F3H, and 11=F2H).

Bit 10 (X4) provides the fifth bit and most significant bit for the X register identifier.

Bits 14:11, shown as V3V2V1V0 may be used to: 1) encode the first source register operand, specified in inverted (1s complement) form and valid for instructions with 2 or more source operands; 2) encode a new data destination register operand, specified in 1s complement form for certain vector shifts; or 3) not encode any operand, the field is reserved and should contain a certain value, such as 1111b.

Bit 15 (W) may serve as an opcode extension bit or operand size promotion.

Bits 16:17 are zero.

Bit 18 is used to indicate a flags update suppression in most examples. When set to 1, the carry, sign, zero, adjust, overflow, and parity bits are not updated. In some examples, instructions for increment, decrement, negation, addition, subtraction, AND, OR, shift arithmetically left, shift logically left, shift arithmetically right, shift logically right, rotate left, rotate right, multiply, divide, population count, leading zero count, total zero count, etc. support flag suppression.

Bit 19 can be combined with bits 14:11 to encode a register in a new data destination.

Bit 20 indicates a NDD in some examples. In some examples, if EVEX2.ND=0, there is no NDD and EVEX2.[V4,V3,V2,V1,V0] must be all zero. In some examples, if EVEX2.ND=1, there is an NDD whose register ID is encoded by EVEX2.[V4,V3,V2,V1,V0]. Although some instructions do not support NDD, the EVEX2.ND bit may be used to control whether its destination register has its upper bits (namely, bits [63:operand size]) zeroed when operand size is 8-bit or 16-bit. That is, if EVEX2.ND=1, the upper bits are always zeroed; otherwise, they keep the old values when operand size is 8-bit or 16-bit. For these instructions, EVEX2.[V4,V3,V2,V1,V0] is all zero.

Bit 21 is used in some examples to indicate exceptions are to be suppressed.

In some examples, R3, R4, B3, X3, X4, V3, V2, V1, V0 are inverted. In some examples, B4 and X5 are repurposed reserved bits of an existing prefix that are used to provide the fifth and most significant bits of the B and X register identifiers. Their polarities are chosen so that the current fixed values at those two locations encode logical 0 after the repurposing. (In other words, the current fixed value at B4 is 0 and that at X4 is 1.)

Example examples of source and/or destination encoding in instructions using the EVEX2 prefix 1501(C) are detailed in the following table.

| | 4 | 3 | [2:0] | REG. TYPE | COMMON USAGES |
|---|---|---|---|---|---|
| R | R4 | R3 | MOD R/M | GPR | Destination |
| register | | | reg | | or Source |
| B | B4 | B3 | MOD R/M | GPR | Destination |
| register | | | reg | | or Source |
| V | V4 | V3V2V1V0 | | GPR | 2nd Source |
| register | | | | | or Destination |
| RM | B4 | B3 | MOD R/M | GPR | 1st Source |
| | | | R/M | | or Destination |
| BASE | B4 | B3 | MOD R/M | GPR | Memory addressing |
| | | | R/M | | |
| INDEX | X4 | X3 | SIB.index | GPR | Memory addressing |

FIG. 20(D) illustrates fourth examples of the third prefix. In some examples, the prefix 1501(C) is an example of an EVEX2 prefix. The EVEX2 prefix 1501(C) is a four-byte prefix.

The extended EVEX prefix is an extension of the current 4-byte EVEX prefix and is used to provide APX features for legacy instructions which cannot be provided by the REX2 prefix (in particular, the new data destination) and APX extensions of VEX and EVEX instructions. Most bits in the third payload byte (except for the V4 bit) are left unspecified because the payload bit assignment depends on whether the EVEX prefix is used to provide APX extension to a legacy, VEX, or EVEX instruction, the details of which will be given in the subsections below. The byte following the extended EVEX prefix is always interpreted as the main opcode byte. Escape sequences 0x0F, 0x0F38 and 0x0F3A are neither needed nor allowed.

The EVEX2 prefix 1501(C) can encode 32 vector registers (e.g., 128-bit, 256-bit, and 512-bit registers) in 64-bit mode and/or 32 general purpose registers.

The EVEX2 prefix 1501(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the EVEX2 prefix 1501(C) is a format field 2033 that has a value, in some examples, of 0x62. Subsequent bytes are referred to as payload bytes 2035-2039 and collectively form a 24-bit value of P[23:0] providing specific capability in the form of one or more fields (detailed herein).

Bits 0:2 (M0, M1, and M2) of a first payload byte (payload byte 0) 2039 are used to provide an opcode map identification. Note that this is limited to 8 maps.

Bit 3 (B4) provides the fifth bit and most significant bit for the B register identifier.

Bit 4 (R4) provides the fifth bit and most significant bit for the R register identifier.

Bit 5 (B3), bit 6 (X3), and bit 7 (R3) provide the fourth bit for the B, X, and R register identifiers respectively when combined with a MOD R/M register field (R register), a MOD R/M R/M field (B register), and/or a SIB.INDEX field (X register).

Bits 9:8 provide opcode extensionality equivalent to some legacy prefixes (e.g., 00=no prefix, 01=66H, 10=F3H, and 11=F2H).

Bit 10 (X4) provides the fifth bit and most significant bit for the X register identifier.

Bits 14:11, shown as V3V2V1V0 may be used to: 1) encode the first source register operand, specified in inverted (1s complement) form and valid for instructions with 2 or more source operands; 2) encode a new data destination register operand, specified in 1s complement form for certain vector shifts; or 3) not encode any operand, the field is reserved and should contain a certain value, such as 1111b.

Bit 15 (W) may serve as an opcode extension bit or operand size promotion.

Bits 16:17 are zero.

Bit 18 is used to indicate a flags update suppression in most examples. When set to 1, the carry, sign, zero, adjust, overflow, and parity bits are not updated.

Bit 19 can be combined with bits 14:11 to encode a register in a new data destination.

Bits 20, 22, and 23 are zero.

Bit 21 is a length specifier field

In some examples, R3, R4, B3, X3, X4, V3, V2, V1, V0 are inverted. In some examples, B4 and X5 are repurposed reserved bits of an existing prefix that are used to provide the fifth and most significant bits of the B and X register identifiers. Their polarities are chosen so that the current fixed values at those two locations encode logical 0 after the repurposing. (In other words, the current fixed value at B4 is 0 and that at X4 is 1.)

Example examples of source and/or destination encoding in instructions using the EVEX2 prefix 1501(C) are detailed in the following table.

| | 4 | 3 | [2:0] | REG. TYPE | COMMON USAGES |
|---|---|---|---|---|---|
| R | R4 | R3 | MOD R/M | GPR | Destination |
| register | | | reg | | or Source |
| B | B4 | B3 | MOD R/M | GPR | Destination |
| register | | | reg | | or Source |
| V | V4 | V3V2V1V0 | | GPR | 2nd Source |
| register | | | | | or Destination |
| RM | B4 | B3 | MOD R/M | GPR | 1st Source |
| | | | R/M | | or Destination |
| BASE | B4 | B3 | MOD R/M | GPR | Memory addressing |
| | | | R/M | | |
| INDEX | X4 | X3 | SIB.index | GPR | Memory addressing |

FIG. 20(E) illustrates fifth examples of the third prefix. In some examples, the prefix 1501(C) is an example of an EVEX2 prefix. The EVEX2 prefix 1501(C) is a four-byte prefix.

The EVEX2 prefix 1501(C) can encode at least 32 vector registers (e.g., 128-bit, 256-bit, and 512-bit registers) in 64-bit mode and/or up to 64 general purpose registers. I

The EVEX2 prefix 1501(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the EVEX2 prefix 1501(C) is a format field 2043 that has a value, in one example, of 0x62. Subsequent bytes are referred to as payload bytes 2045-2049 and collectively form a 24-bit value of P[23:0] providing specific capability in the form of one or more fields (detailed herein).

Bits 0:2 (M0, M1, and M2) of a first payload byte (payload byte 0) 2039 are used to provide an opcode map identification. Note that this is limited to 8 maps.

Bit 3 (B4) provides the fifth bit and most significant bit for the B register identifier.

Bit 4 (R4) provides the fifth bit and most significant bit for the R register identifier.

Bit 5 (B3), bit 6 (X3), and bit 7 (R3) provide the fourth bit for the B, X, and R register identifiers respectively when combined with a MOD R/M register field (R register), a MOD R/M R/M field (B register), and/or a SIB.INDEX field (X register).

Bits 9:8 provide opcode extensionality equivalent to some legacy prefixes (e.g., 00=no prefix, 01=66H, 10=F3H, and 11=F2H).

Bit 10 (X4) provides the fifth bit and most significant bit for the X register identifier.

Bits 14:11, shown as V3V2V1V0 may be used to: 1) encode the first source register operand, specified in inverted (1s complement) form and valid for instructions with 2 or more source operands; 2) encode a new data destination register operand, specified in 1s complement form for certain vector shifts; or 3) not encode any operand, the field is reserved and should contain a certain value, such as 1111b.

Bit 15 (W) may serve as an opcode extension bit or operand size promotion.

Bits 16:18 specify the index of a register in the opmask (writemask) registers (e.g., writemask/predicate registers 2615). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

Bit 19 can be combined with bits 14:11 to encode a register in a new data destination.

Bit 20 encodes multiple functionalities, which differ across different classes of instructions and can affect the meaning of the vector length/rounding control specifier field bits 21:22]).

Bit 23 indicates support for merging-writemasking (e.g., when set to 0) or support for zeroing and merging-writemasking (e.g., when set to 1).

In some examples, R3, R4, B3, X3, X4, V3, V2, V1, V0 are inverted. In some examples, B4 and X5 are repurposed reserved bits of an existing prefix that are used to provide the fifth and most significant bits of the B and X register identifiers. Their polarities are chosen so that the current fixed values at those two locations encode logical 0 after the repurposing. (In other words, the current fixed value at B4 is 0 and that at X4 is 1.)

Example examples of source and/or destination encoding in instructions using the EVEX2 prefix 1501(C) are detailed in the following table.

| | 4 | 3 | [2:0] | REG. TYPE | COMMON USAGES |
|---|---|---|---|---|---|
| R | R4 | R3 | MOD R/M | GPR | Destination |
| register | | | reg | | or Source |
| B | B4 | B3 | MOD R/M | GPR | Destination |
| register | | | reg | | or Source |
| V | V4 | V3V2V1V0 | | GPR | 2nd Source |
| register | | | | | or Destination |
| RM | B4 | B3 | MOD R/M | GPR | 1st Source |
| | | | R/M | | or Destination |
| BASE | B4 | B3 | MOD R/M | GPR | Memory addressing |
| | | | R/M | | |
| INDEX | X4 | X3 | SIB.index | GPR | Memory addressing |

The table below illustrates the new prefixes and how they differ from at least one legacy format. Note that OP is an operation to be performed.

| Legacy | APX REX2 | APX EVEX2 |
|---|---|---|
| Format | (No-NDD) Prefix | (NDD) Prefix |
| OP R/M, Reg | OP R/M, Reg | V = OP R/M, Reg |
| OP Reg, R/M | OP Reg, R/M | V = OP Reg, R/M |
| OP R/M, Imm | OP R/M, Imm | V = OP R/M, Imm |
| OP R/M | OP R/M | V = OP R/M |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

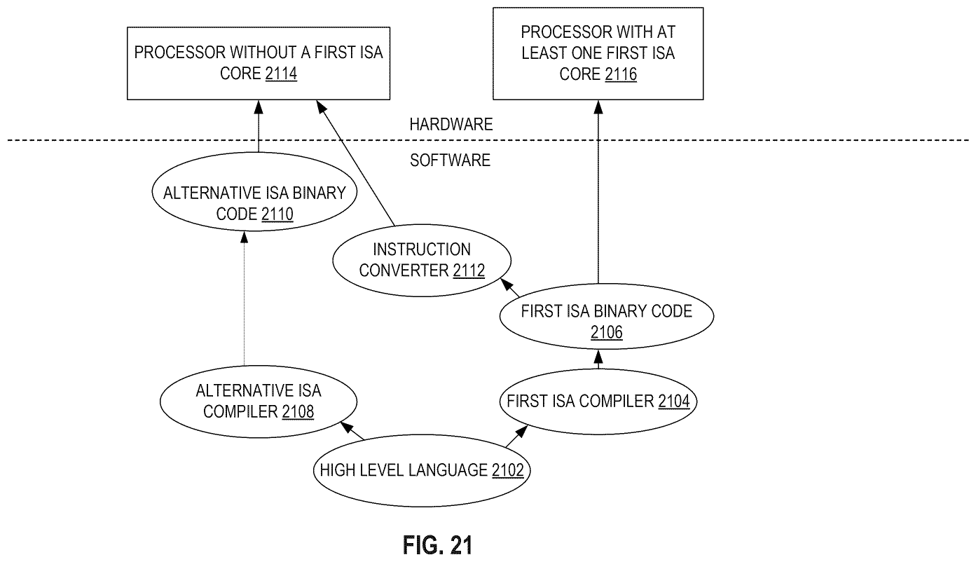

FIG. 21 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 21 shows a program in a high-level language 2102 may be compiled using a first ISA compiler 2104 to generate first ISA binary code 2106 that may be natively executed by a processor with at least one first ISA core 2116. The processor with at least one first ISA core 2116 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 2104 represents a compiler that is operable to generate first ISA binary code 2106 (e.g., object code) that can, with or without additional linkage processing, be executed on the processor with at least one first ISA core 2116. Similarly, FIG. 21 shows the program in the high-level language 2102 may be compiled using an alternative ISA compiler 2108 to generate alternative ISA binary code 2110 that may be natively executed by a processor without a first ISA core 2114. The instruction converter 2112 is used to convert the first ISA binary code 2106 into code that may be natively executed by the processor without a first ISA core 2114. This converted code is not necessarily to be the same as the alternative ISA binary code 2110; however, the converted code will accomplish the general operation and be made up of instructions from the alternative ISA. Thus, the instruction converter 2112 represents software, firmware, hardware, or a combination thereof that, through emulation, simulation or any other process, allows a processor or other electronic device that does not have a first ISA processor or core to execute the first ISA binary code 2106.

### IP Core Implementations

One or more aspects of at least some examples may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the examples described herein.

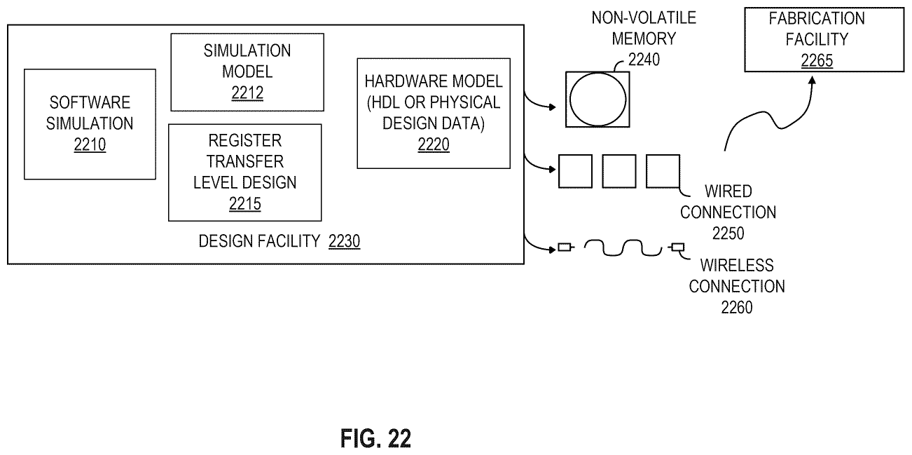

FIG. 22 is a block diagram illustrating an IP core development system 2200 that may be used to manufacture an integrated circuit to perform operations according to some examples. The IP core development system 2200 may be used to generate modular, re-usable designs that can be incorporated into a larger design or used to construct an entire integrated circuit (e.g., an SOC integrated circuit). A design facility 2230 can generate a software simulation 2210 of an IP core design in a high-level programming language (e.g., C/C++). The software simulation 2210 can be used to design, test, and verify the behavior of the IP core using a simulation model 2212. The simulation model 2212 may include functional, behavioral, and/or timing simulations. A register transfer level (RTL) design 2215 can then be created or synthesized from the simulation model 2212. The RTL design 2215 is an abstraction of the behavior of the integrated circuit that models the flow of digital signals between hardware registers, including the associated logic performed using the modeled digital signals. In addition to an RTL design 2215, lower-level designs at the logic level or transistor level may also be created, designed, or synthesized. Thus, the particular details of the initial design and simulation may vary.

The RTL design 2215 or equivalent may be further synthesized by the design facility into a hardware model 2220, which may be in a hardware description language (HDL), or some other representation of physical design data. The HDL may be further simulated or tested to verify the IP core design. The IP core design can be stored for delivery to a fabrication facility 2265 using non-volatile memory 2240 (e.g., hard disk, flash memory, or any non-volatile storage medium). Alternatively, the IP core design may be transmitted (e.g., via the Internet) over a wired connection 2250 or wireless connection 2260. The fabrication facility 2265 may then fabricate an integrated circuit that is based at least in part on the IP core design. The fabricated integrated circuit can be configured to perform operations in accordance with at least some examples described herein.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Examples include, but are not limited to:

1. An apparatus comprising:
a processor core at least comprising:
   decoder circuitry to at least decode an accelerator task instruction,
   scheduling circuitry to at least schedule the decoded accelerator task instruction to execute on an accelerator,
   a port coupled to the accelerator, and
   at least one register to store a result of the decoded accelerator task instruction; and
the accelerator to execute the decoded accelerator task instruction and provide the result to the processor core through the port coupled to the accelerator.
   2. The apparatus of example 1, wherein the accelerator supports matrix operations.
   3. The apparatus of example 1, wherein the accelerator supports cryptographic operations.
   4. The apparatus of example 1, wherein the accelerator supports pointwise arithmetic operations.
   5. The apparatus of any of examples 1-4, wherein the accelerator comprises an address generation unit to generate an address to retrieve source data from.
   6. The apparatus of example 5, wherein the address is for memory.
   7. The apparatus of example 6, wherein the address is for cache of the processor core.
   8. The apparatus of example 1, wherein the processor core further comprises and reorder buffer to track accelerator task instructions.
   9. The apparatus of any of examples 1-8, wherein the accelerator task instruction comprises fields for an opcode, one or more source data locations, and one or more destination register locations.
   10. The apparatus of any of examples 1-9, wherein the apparatus is a system-on-a-chip.
   11. A computer-implemented method comprising:
decoding an accelerator task instruction in a processor core;
issuing the decoded accelerator task instruction to an accelerator using a port of the processor core;
receiving a result of the decoded accelerator task instruction from the accelerator on the port of the processor core; and
storing the result in at least one destination register identified by the accelerator task instruction.
   12. The computer-implemented method of example 11, further comprising:
updating an entry in a reorder buffer for the processor core for the decoded accelerator task instruction.
   13. The computer-implemented method of any of examples 11-12, further comprising:
the accelerator performing one or more operations in accordance with an opcode of the decoded accelerator task instruction; and
transmitting a result of performing one or more operations in accordance with an opcode of the decoded accelerator task instruction to the processor core.
   14. The computer-implemented method of any of examples 11-13, wherein the accelerator task instruction comprises fields for an opcode, one or more source data locations, and one or more destination register locations.
   15. The computer-implemented method of example 14, further comprising:
generating an address to retrieve source data from using the accelerator; and
loading the source data from the address.
   16. The computer-implemented method of example 15, wherein the address is for memory.
   17. The computer-implemented method of example 15, wherein the address is for cache of the processor core.
   18. A system comprising:
memory to store data; and
a processor comprising:
   a processor core at least comprising:
      decoder circuitry to at least decode an accelerator task instruction,
      scheduling circuitry to at least schedule the decoded accelerator task instruction to execute on an accelerator,
      a port coupled to the accelerator, and
      at least one register to store a result of the decoded accelerator task instruction; and
   the accelerator to execute the decoded accelerator task instruction using data stored in one of the memory or a cache of the processor core and provide a result to the processor core through the port coupled to the accelerator.
      19. The system of example 18, wherein the accelerator supports matrix operations.
      20. The system of example 18, wherein the accelerator task instruction comprises fields for an opcode, one or more source data locations, and one or more destination register locations.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a processor core at least comprising:
decoder circuitry to at least decode an accelerator task instruction,
scheduling circuitry to at least schedule the decoded accelerator task instruction to execute on an accelerator,
a port coupled to the accelerator, and
at least one register to store a result of the decoded accelerator task instruction; and
the accelerator to execute the decoded accelerator task instruction and provide the result to the processor core through the port coupled to the accelerator.

2. The apparatus of claim 1, wherein the accelerator supports matrix operations.

3. The apparatus of claim 1, wherein the accelerator supports cryptographic operations.

4. The apparatus of claim 1, wherein the accelerator supports pointwise arithmetic operations.

5. The apparatus of claim 1, wherein the accelerator comprises an address generation unit to generate an address to retrieve source data from.

6. The apparatus of claim 5, wherein the address is for memory.

7. The apparatus of claim 6, wherein the address is for cache of the processor core.

8. The apparatus of claim 1, wherein the processor core further comprises and reorder buffer to track accelerator task instructions.

9. The apparatus of claim 1, wherein the accelerator task instruction comprises fields for an opcode, one or more source data locations, and one or more destination register locations.

10. The apparatus of claim 1, wherein the apparatus is a system-on-a-chip.

11. A computer-implemented method comprising:
decoding an accelerator task instruction in a processor core;
issuing the decoded accelerator task instruction to an accelerator using a port of the processor core;
receiving a result of the decoded accelerator task instruction from the accelerator on the port of the processor core; and
storing the result in at least one destination register identified by the accelerator task instruction.

12. The computer-implemented method of claim 11, further comprising:
updating an entry in a reorder buffer for the processor core for the decoded accelerator task instruction.

13. The computer-implemented method of claim 11, further comprising:
the accelerator performing one or more operations in accordance with an opcode of the decoded accelerator task instruction; and
transmitting a result of performing one or more operations in accordance with an opcode of the decoded accelerator task instruction to the processor core.

14. The computer-implemented method of claim 11, wherein the accelerator task instruction comprises fields for an opcode, one or more source data locations, and one or more destination register locations.

15. The computer-implemented method of claim 14, further comprising:
generating an address to retrieve source data from using the accelerator; and
loading the source data from the address.

16. The computer-implemented method of claim 15, wherein the address is for memory.

17. The computer-implemented method of claim 15, wherein the address is for cache of the processor core.

18. A system comprising:
memory to store data; and
a processor comprising:
a processor core at least comprising:
decoder circuitry to at least decode an accelerator task instruction,
scheduling circuitry to at least schedule the decoded accelerator task instruction to execute on an accelerator,
a port coupled to the accelerator, and
at least one register to store a result of the decoded accelerator task instruction; and
the accelerator to execute the decoded accelerator task instruction using data stored in one of the memory or a cache of the processor core and provide a result to the processor core through the port coupled to the accelerator.

19. The system of claim 18, wherein the accelerator supports matrix operations.

20. The system of claim 18, wherein the accelerator task instruction comprises fields for an opcode, one or more source data locations, and one or more destination register locations.
